(19) United States
(12) Patent Application Publication
(10) Pub. No.: US 2014/0022476 A1
(43) Pub. Date: Jan. 23, 2014

(54) DISPLAY PANEL AND METHOD OF DRIVING THE SAME

(71) Applicant: SAMSUNG DISPLAY CO., LTD., Yongin-city (KR)

(72) Inventors: Ji-Hong PARK, Suwon-si (KR); II-Ho Lee, Hwaseong-si (KR); In-Cheol Kim, Asan-si (KR); Seung-Ho Nam, Seongnam-si (KR); Moon-Sung Choi, Incheon (KR); Seong-Mo Hwang, Seongnam-si (KR)

(73) Assignee: Samsung Display Co., Ltd., Yongin-city (KR)

(21) Appl. No.: 13/692,328

(22) Filed: Dec. 3, 2012

(30) Foreign Application Priority Data
Jul. 23, 2012 (KR) 10-2012-0079782

(51) Int. Cl. G02F 1/133; G02F 1/1333

(52) U.S. Cl. CPC G02F 1/13306; G02F 1/13338
USPC 349/41

(57) ABSTRACT

A display panel includes a first substrate and a second substrate. The first substrate includes a first base substrate having a plurality of touch cells, a plurality of gate lines formed on the first base substrate and disposed in the touch cells, and a plurality of sense lines disposed in the touch cells and respectively overlapping with at least two gate lines among the gate lines.

The second substrate includes a second base substrate facing the first base substrate. Thus, a touch sense rate of the display panel and a display apparatus may be increased.

### CROSS-REFERENCE TO RELATED APPLICATION

This application claims priority from and the benefit of Korean Patent Application No. 10-2012-0079782, filed on Jul. 23, 2012, which is hereby incorporated by reference for all purposes as if fully set forth herein.

### BACKGROUND

1. Field

Exemplary embodiments of the present invention relate to a display panel and a method of driving the display panel. More particularly, exemplary embodiments of the present invention relate to a display panel capable of sensing a touch and a method of driving the display panel.

2. Discussion of the Background

Recently, a display apparatus, such as a liquid crystal display panel capable of sensing a touch, has been developed so as to prevent an increase in thickness of the display apparatus resulting from separate formation of a touch panel and a display panel.

The display panel capable of sensing the touch includes a thin-film transistor substrate having a gate line and a thin-film transistor, and a color filter substrate having a color filter. The thin-film transistor substrate is disposed at an upper portion, and the color filter substrate is disposed at a lower portion. Thus, the thin-film substrate is disposed on the color filter substrate.

A touch sense part configured to sense the touch includes a sense line, and the sense line forms a capacitance with the gate line or a gate electrode of the thin-film transistor to sense the touch. In this case, a touch sense frequency is substantially the same as a driving frequency of the gate lines and a driving frequency of the display panel.

Thus, a touch sense rate of the display panel depends on the driving frequency of the gate lines and the driving frequency of the display panel, and the touch sense rate is limited.

### SUMMARY

Exemplary embodiments of the present invention provide a display panel capable of increasing a touch sense rate.

Exemplary embodiments of the present invention also provide a method of driving the above-mentioned display panel.

Additional features of the invention will be set forth in the description which follows, and in part will be apparent from the description, or may be learned by practice of the invention.

An exemplary embodiment of the present invention discloses a display panel includes an upper substrate and a lower substrate. The upper substrate includes a first base substrate having a plurality of touch cells, a plurality of gate lines formed on the first base substrate and disposed in the touch cells, and a plurality of sense lines disposed in the touch cells and respectively overlapping with at least two gate lines among the gate lines. The lower substrate includes a second base substrate facing the first base substrate.

An exemplary embodiment of the present invention also discloses a display panel includes a first substrate and a second substrate. The first substrate includes a first base substrate having a plurality of touch cells, a plurality of gate lines formed on the first base substrate and disposed in the touch cells, transmit lines disposed in the touch cells and respectively connected to a first area gate line and a second area gate line, and a receive line forming a capacitance with the transmit lines. The first area gate line and the second area gate line are respectively disposed in a first area and a second area defined based on a number of the gate lines. The second substrate includes a second base substrate facing the first base substrate.

An exemplary embodiment of the present invention provides a method in which a first gate line group including a first gate line and (nA+1)-th gate lines spaced apart from the first gate line at an interval of A (n is a natural number and A is a natural number equal to or greater than two) is driven. A second gate line group including a second gate line and (nA+2)-th gate lines spaced apart from the second gate line at the interval of the A is driven. The first gate line overlaps with a first sense line, and the first gate line group is included in a plurality of gate lines disposed in a plurality of touch cells. The second gate line overlaps with a second sense line adjacent to the first sense line, and the second gate line group is included in the gate lines.

It is to be understood that both the foregoing general description and the is following detailed description are exemplary and explanatory and are intended to provide further explanation of the invention as claimed.

### BRIEF DESCRIPTION OF THE DRAWINGS

The exemplary embodiment accompanying drawings, which are included to provide a further understanding of the invention and are incorporated in and constitute a part of this specification, illustrate embodiments of the invention, and together with the description serve to explain the principles of the invention.

FIG. 1 is a block diagram illustrating a display apparatus according to an exemplary embodiment of the present invention.

FIG. 2 is a plan view illustrating a portion of a display apparatus of FIG. 1.

FIG. 3 is a cross-sectional view taken along a line I-I′ of FIG. 2.

FIG. 4 is a waveform diagram illustrating gate signals applied to gate lines of FIG. 1.

FIG. 5 is a block diagram illustrating an outside apparatus providing image data to a timing control part.

FIG. 6A is a conceptual diagram illustrating a digital image data of FIG. 5.

FIG. 6B is a conceptual diagram illustrating the image data of FIG. 5.

FIG. 7 is a flow chart illustrating a method of driving a display panel of FIG. 1.

FIG. 8 is a block diagram illustrating a display apparatus according to another exemplary embodiment of the present invention.

FIG. 9 is a cross-sectional view illustrating a display panel of FIG. 8.

FIG. 10 is a waveform diagram illustrating gate signals applied to gate lines of FIG. 8.

FIG. 11 is a flow chart illustrating a method of a driving a display panel driving a display panel of FIG. 8.

FIG. 12 is a plan view illustrating a display panel according to still another exemplary embodiment of the present invention.

FIG. 13 is a plan view illustrating a portion of the display panel of FIG. 12.

FIG. 14 is a cross-sectional view taken along a line II-II; of FIG. 13.

FIG. 15 is an enlarged view illustrating a first transmit line and a receive line of FIG. 12.

FIG. 16 is a cross-sectional view taken along a line III-III′ of FIG. 15.

FIG. 17 is a waveform diagram illustrating gate signals applied to gate lines of FIG. 12.

FIGS. 18A, 18B, 18C, 18D, and 18E are cross-sectional views illustrating a method of manufacturing the display panel of FIG. 14.

FIG. 19 a plan view illustrating a display panel according to still another exemplary embodiment of the present invention.

FIG. 20 is a plan view illustrating a portion of the display panel of FIG. 19.

FIG. 21 is a cross-sectional view taken along a line IV-IV′ of FIG. 20.

FIGS. 22A, 22B, 22C, and 22D are cross-sectional views illustrating a method of manufacturing the display panel of FIG. 21.

FIG. 23 is a plan view illustrating a display panel according to still another exemplary embodiment of the present invention.

FIG. 24 is a waveform diagram illustrating gate signals applied to gate lines of FIG. 23.

FIG. 25 is a plan view illustrating a display panel according to still another exemplary embodiment of the present invention.

FIG. 26 is a circuit diagram illustrating a connection between a first transmit line and gate lines of FIG. 25.

FIG. 27 is a circuit diagram illustrating a connection between a first transmit line and gate lines according to still another exemplary embodiment of the present invention.

FIG. 28 is a waveform diagram illustrating gate signals applied to gate lines and a first transmit signal applied to a first transmit line of FIG. 27.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity Like reference numerals in the drawings denote like elements.

It will be understood that when an element or layer is referred to as being “on” or “connected to” another element or layer, it can be directly on or directly connected to the other element or layer, or intervening elements or layers may be present. In contrast, when an element is referred to as being “directly on” or “directly connected to” another element or layer, there are no intervening elements or layers present. It will be understood that for the purposes of this disclosure, “at least one of X, Y, and Z” can be construed as X only, Y only, Z only, or any combination of two or more items X, Y, and Z (e.g., XYZ, XYY, YZ, ZZ).

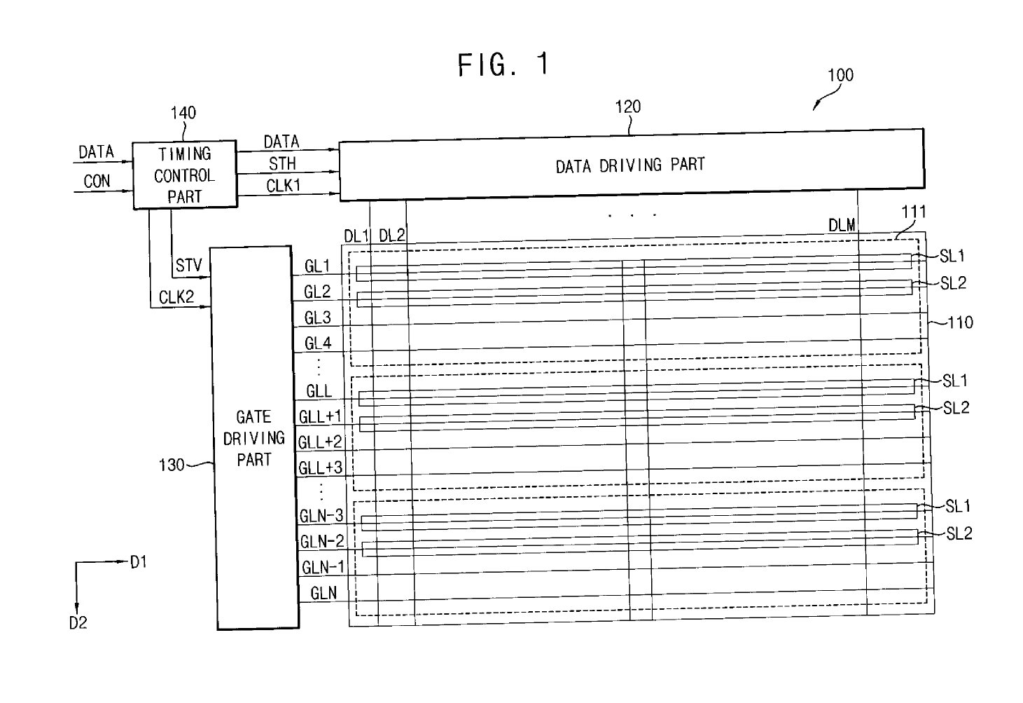

FIG. 1 is a block diagram illustrating a display apparatus according to an exemplary embodiment of the present invention.

Referring to FIG. 1, the display apparatus 100 according to the present exemplary embodiment includes a display panel 110, a data driving part 120, a gate driving part 130, and a timing control part 140.

The display panel 110 receives an image data DATA to display an image. The display panel 110 includes gate lines GL1, GL2, . . . , GLN substantially parallel with a first direction D1, data lines DL1, DL2, . . . , DLM substantially parallel with a second direction D2 substantially perpendicular to the first direction D1, and a plurality of pixels. The first direction D1 may be substantially parallel with a long side of the display panel 110, and the second direction D2 may be substantially parallel with a short side of the display panel 110. For example, the display panel 110 may include M×N (M and N are natural numbers) numbers of the pixels. Each of the pixels includes a thin-film transistor electrically connected to the gate line and the data line, a liquid crystal capacitor, and a storage capacitor connected to the thin-film transistor.

The display panel 110 includes a plurality of touch cells 111. Each of the touch cells 111 may be a unit area in which a touch is sensed. The gate lines may be disposed in each of the touch cells 111. For example, about twenty gate lines may be disposed in each of the touch cells 111.

In addition, each of the touch cells 111 includes a first sense line SL1 and a second sense line SL2. The first sense line SL1 overlaps with one of the gate lines in the touch is cell 111, and the second sense line SL2 is adjacent to the first sense line SL1 and overlaps with another of the gate lines in the touch cell 111. Specifically, the first sense line SL1 overlaps with one of odd-numbered gate lines GL1, GL3, . . . , GLN−1, and the second sense line SL2 overlaps with one of even-numbered gate lines GL2, GL4, . . . , GLN.

The timing control part 140 receives the image data DATA and a control signal CON from an external source. The control signal CON may include a horizontal synchronous signal, a vertical synchronous signal, and a clock signal (not shown).

The timing control part 140 generates a data start signal STH using the horizontal synchronous signal and outputs the data start signal STH to the data driving part 120. In addition, the timing control part 140 generates a gate start signal STV using the vertical synchronous signal and outputs the gate start signal STV to the gate driving part 130. In addition, the timing control part 140 generates a first clock signal CLK1 and a second clock signal CLK2 using the clock signal, and outputs the first clock signal CLK1 to the data driving part 120 and the second clock signal CLK2 to the gate driving part 130.

The data driving part 120 outputs the image data DATA to the data lines DL1, DL2, . . . , DLM in response to the first clock signal CLK1 and the data start signal STH provided from the timing control part 140.

The gate driving part 130 generates gate signals using the gate start signal STV and the second clock signal SLK2 provided from the timing control part 140, and outputs the gate signals to the gate lines GL1, GL2, . . . , GLN.

The gate driving part 130 drives the gate lines GL1, GL2, . . . , GLN per two gate lines. Specifically, the gate driving part 130 drives the odd-numbered gate lines GL1, GL3, . . . , GLN−1, and drives the even-numbered gate lines GL2, GL4, . . . , GLN. Thus, the gate driving is part 130 drives the gate lines GL1, GL2, . . . , GLN in an interlaced scanning method. The odd-numbered gate lines GL1, GL3, . . . , GLN−1 may be a first gate line group and the even-numbered gate lines GL2, GL4, . . . , GLN may be a second gate line group.

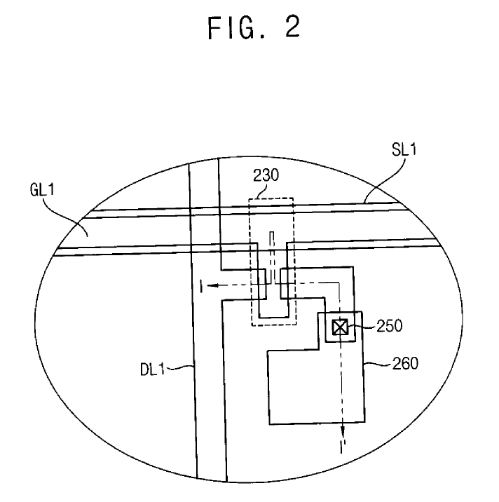

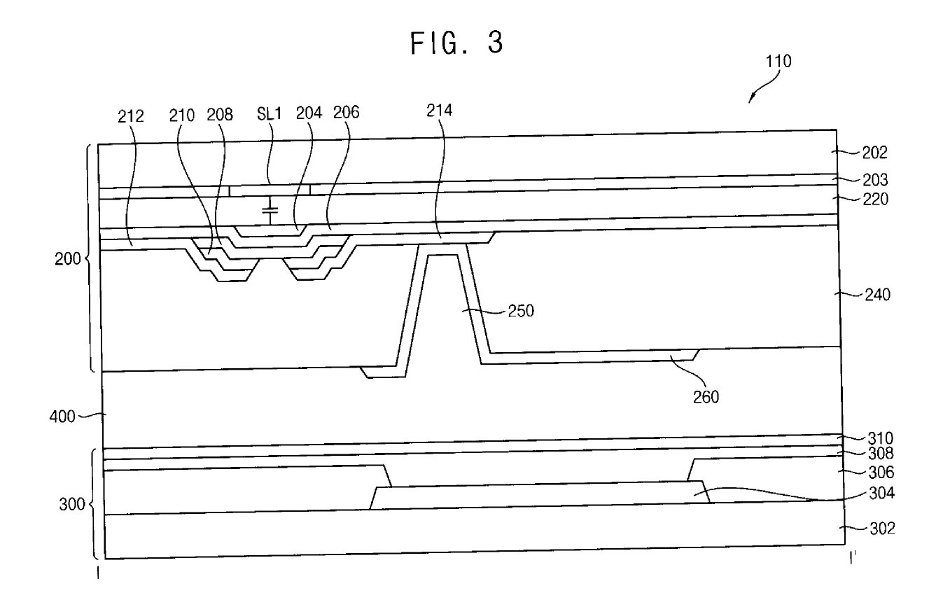

FIG. 2 is a plan view illustrating a portion of the display apparatus 100 of FIG. 1, and FIG. 3 is a cross-sectional view taken along a line I-I′ of FIG. 2.

Referring to FIGS. 1 to 3, the display panel 110 includes a first substrate 200, a second substrate 300, and a liquid crystal layer 400.

The first substrate 200 may be a display substrate, and the first substrate 200 may be a thin-film transistor substrate including a thin-film transistor 230. In addition, the first substrate 200 may be an upper substrate of the display panel 110.

The first substrate 200 includes a first base substrate 202, a sense line layer 203 formed on the first base substrate 202 and having the first sense line SL1, an insulating layer 220 formed on the sense line layer 203, the thin-film transistor 230 formed on the insulating layer 220, an organic insulating layer 240 formed on the thin-film transistor 230, and a pixel electrode 260 formed on the organic insulating layer 240 and electrically connected with a drain electrode 214 of the thin-film transistor 230 through a contact hole 250 formed through the organic insulating layer 240.

The thin-film transistor 230 includes a gate electrode 204 formed on the insulating layer 220 and extended from a first gate line GL1, a gate insulating layer 206 formed on the gate electrode 204, an active layer 208 formed on the gate insulating layer 206, an ohmic-contact layer 210 separately formed on the active layer 208, a source electrode 212, and the drain electrode 214 separately formed on the ohmic-contact layer 210 and spaced apart from each other.

The first sense line SL1 overlaps with the first gate line GL1. A width of the first sense line SL1 may be greater than a width of the first gate line GL1. Alternatively, the width of the first sense line SL1 may be the same as the width of the first gate line GL1.

The insulating layer 220 is disposed between the gate lines GL1, GL2. . . . , GLN and the first and second sense lines SL1 and SL2. Thus, the first sense line SL1 and the first gate line GL1 or the first sense line SL1 and the gate electrode 204 form a capacitance. When the first substrate 200 is touched, the capacitance between the first sense line SL1 and the first gate line GL1 is changed, and thus the display panel 110 including the first substrate 200 may sense a touch.

The second substrate 300 includes a second base substrate 302 facing the first base substrate 202 of the first substrate 200, a color filter 304 formed on the second base substrate 302, a light shielding layer 306 formed on the color filter 304, an over-coating layer 308 formed on the color filter 304 and the light shielding layer 306, and a common electrode 310 formed on the over-coating layer 308. The second substrate 300 may be a lower substrate of the display panel 110.

The liquid crystal layer 400 is interposed between the first substrate 200 and the second substrate 300, and includes a liquid crystal aligned by an electric field between the pixel electrode 260 of the first substrate 200 and the common electrode 310 of the second substrate 300.

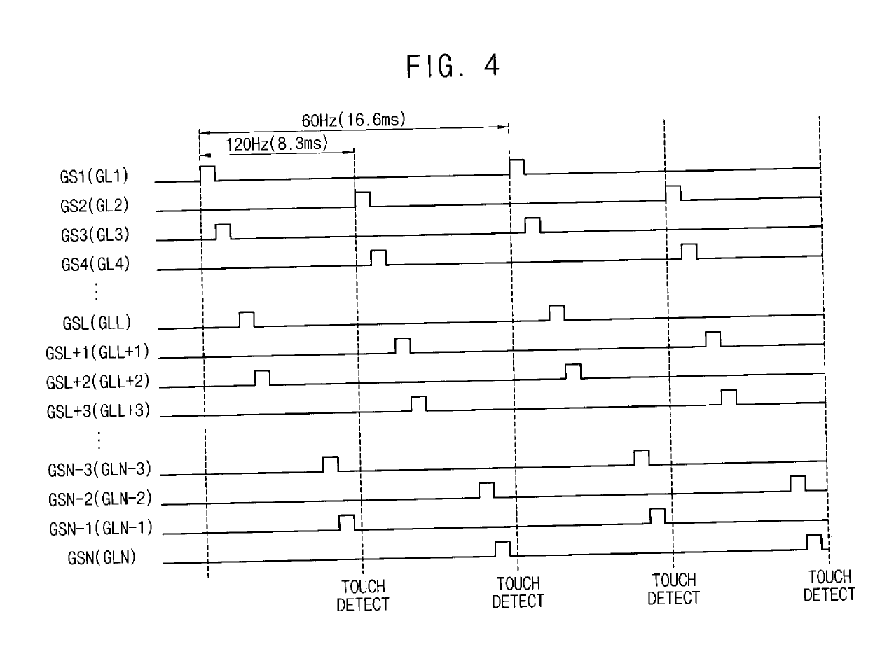

FIG. 4 is a waveform diagram illustrating the gate signals applied to the gate lines GL1, GL2, . . . , GLN of FIG. 1.

Referring to FIGS. 1 and 4, the gate lines GL1, GL2, . . . , GLN are driven per two gate lines. Specifically, the odd-numbered gate lines GL1, GL3, . . . , GLN−1 are driven, and the is even-numbered gate lines GL2, GL4, . . . , GLN are driven. When a frame frequency of the image data DATA is about 60 hertz (Hz), the gate lines GL1, GL2, . . . , GLN are driven at a frequency of about 60 Hz. Thus, a driving frequency of the display panel 110 is about 60 Hz, and a driving period of the gate lines GL1, GL2, . . . , GLN is about 16.6 milliseconds (ms).

When the odd-numbered gate lines GL1, GL3, . . . , GLN−1 are driven, the display panel 110 may sense the touch because the first sense line SL1 overlaps with the odd-numbered gate lines GL1, GL3, . . . , GLN−1. When the even-numbered gate lines GL2, GL4, . . . , GLN are driven, the display panel 110 may sense the touch because the second sense line SL2 overlaps with the even-numbered gate lines GL2, GL4, . . . , GLN.

When the gate lines GL1, GL2, . . . , GLN are driven, the display panel 110 senses the touch twice, and thus the display panel 110 may sense the touch at a frequency of about 120 Hz. Thus, a touch sense frequency of the display panel 110 is about 120 Hz, and a touch sense period of the display panel 110 is about 8.3 ms.

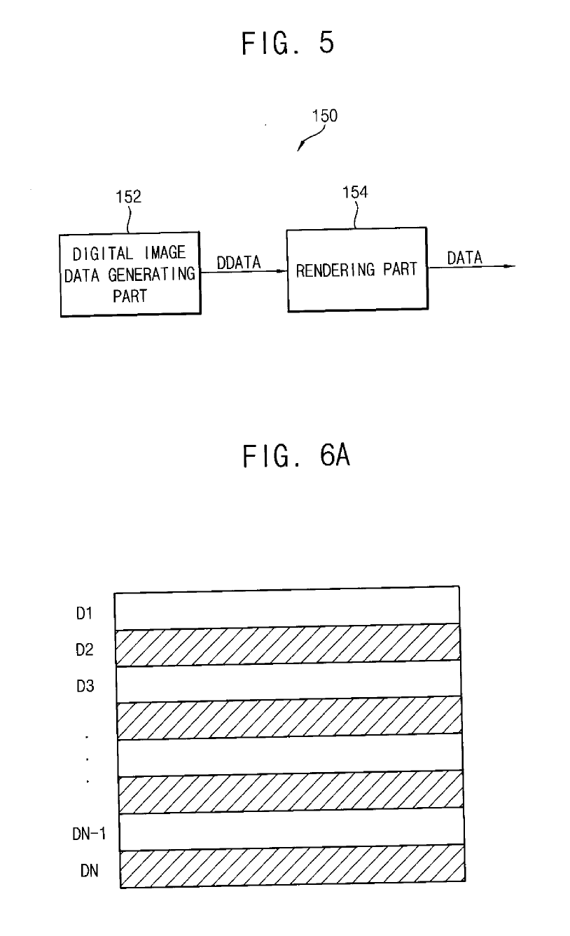

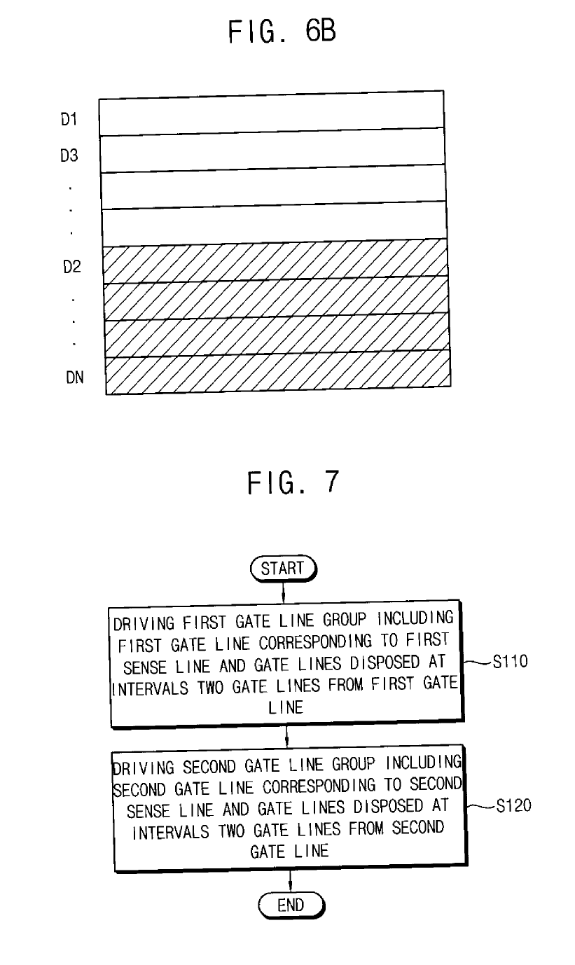

FIG. 5 is a block diagram illustrating an external apparatus providing the image data DATA to the timing control part 140, FIG. 6A is a conceptual diagram illustrating a digital image data DDATA of FIG. 5, and FIG. 6B is a conceptual diagram illustrating the image data DATA of FIG. 5.

Referring to FIGS. 1, 5, 6A and 6B, the external apparatus 150 includes a digital image data generating part 152 and a rendering part 154.

The digital image data generating par 152 generates the digital image data DDATA. For example, the digital image data generating part 152 may be a graphic controller unit. Data D1, . . . , DN applied to the data lines DL1, DL2, . . . , DLM according to a driving of the gate lines GL1, GL2, . . . , GLN are sequentially disposed in the digital image data DDATA.

The rendering part 154 renders the digital image data DDATA to generate the image data DATA. Odd-numbered data D1, D3, . . . , DN−1 applied to the data lines DL1, DL2, . . . , DLM according to a driving of the odd-numbered gate lines GL1, GL3, . . . , GLN−1 and even-numbered data D2, . . . , DN applied to the data lines DL1, DL2, . . . , DLN according to a driving of the even-numbered gate lines GL2, GL4, . . . , GLN are sequentially disposed in the image data DATA outputted from the rendering part 154 because the even-numbered gate lines GL2, GL4, . . . , GLN are driven after the odd-numbered gate lines GL1, GL3, . . . , GLN−1 are driven.

FIG. 7 is a flow chart illustrating a method of driving a display panel driving the display panel 110 of FIG. 1.

Referring to FIGS. 1 to 7, the first gate line group including the first gate line GL1 corresponding to the first sense line SL1 and gate lines GL3, GL5, . . . , GLN−1 disposed at intervals of two numbers of the gate lines from the first gate line GL1 is driven (step S110). The first gate line group may be the odd-numbered gate lines GL1, GL3, . . . , GLN−1. When the odd-numbered gate lines GL1, GL3, . . . , GLN−1 are driven, the display panel 110 may sense the touch because the first sense line SL1 overlaps with the odd-numbered gate lines GL1, GL3, . . . , GLN−1.

The second gate line group including the second gate line GL2 corresponding to the second sense line SL2 and gate lines GL4, GL6, . . . , GLN disposed at intervals of two numbers of the gate lines from the second gate line GL2 is driven (step S120). The second gate line group may be the even-numbered gate lines GL2, GL4, . . . , GLN. When the even-numbered gate lines GL2, GL4, . . . , GLN are driven, the display panel 110 may sense the touch because the second sense line SL2 overlaps with the even-numbered gate lines GL2, GL4, . . . , GLN.

According to the present exemplary embodiment, each of the touch cells 111 is includes the first sense line SL1 overlapping one of the odd-numbered gate lines GL1, GL3, . . . , GLN−1 and second sense line SL2 overlapping one of the even-numbered gate lines GL2, GL4, . . . , GLN. The odd-numbered gate lines GL1, GL3, . . . , GLN−1 are driven, the even-numbered gate lines GL2, GL4, . . . , GLN are driven, and thus the touch sense frequency of the display panel 110 is twice the driving frequency of the display panel 110. Thus, a touch sense rate of the display panel 110 may be increased.

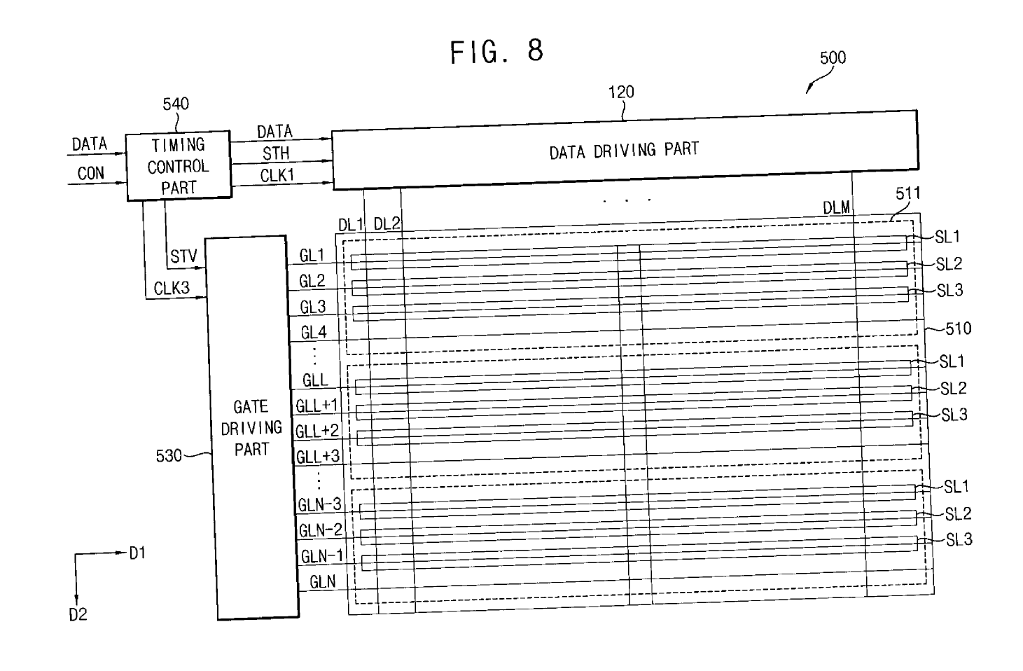

FIG. 8 is a block diagram illustrating a display apparatus according to another exemplary embodiment of the present invention.

The display apparatus 500 according to the present exemplary embodiment is substantially the same as the display apparatus 100 according to the previous exemplary embodiment illustrated in FIG. 1 except for a display panel 510, a gate driving part 530, and a timing control part 540. Thus, the same reference numerals will be used to refer to same or like parts as those described in the previous exemplary embodiment and any further repetitive explanation concerning the above elements will be omitted.

Referring to FIG. 8, the display apparatus according to the present exemplary embodiment includes the display panel 510, the data driving part 120, the gate driving part 530, and the timing control part 540.

The display panel 510 includes a plurality of touch cells 511. A plurality of gate lines may be disposed in each of the touch cells 511. In addition, each of the touch cells 511 includes a first sense line SL1, a second sense line SL2, and a third sense line SL3.

The first sense line SL1 overlaps with one of the gate lines in the touch cell 511, the second sense line SL2 is adjacent to the first sense line SL1 and overlaps with another of the gate lines in the touch cell 511, and the third sense line SL3 is adjacent to the second sense line SL2 and overlaps with still another of the gate lines in the touch cell 511. Specifically, the first sense line SL1 overlaps with one of first gate lines group GL1, GL4, . . . , GLN−3, GLN in each of the touch cells 511, the second sense line SL2 overlaps with one of second gate line group GL2, GL5, . . . , GLN−2 in each of the touch cells 511, and the third sense line SL3 overlaps with one of third gate line group GL3, GL6, . . . , GLN−1 in each of the touch cells 511.

The timing control part 540 generates a third clock signal CLK3 using the clock signal and outputs the third clock signal CLK to the gate driving part 530.

The gate driving part 530 drives the gate lines GL1, GL2, . . . , GLN per three gate lines. Specifically, the gate driving part 530 sequentially drives the first gate line group GL1, GL4, . . . , GLN−3 and GLN spaced apart from each other per three gate lines, the second gate line group GL2, GL5, . . . , GLN−2 spaced apart from each other per three gate lines and adjacent to the first gate line group GL1, GL4, . . . , GLN−3 and GLN, and the third gate line group GL3, GL6, . . . , GLN−1 spaced apart from each other per three gate lines and adjacent to the second gate line group GL2, GL5, . . . , GLN−2.

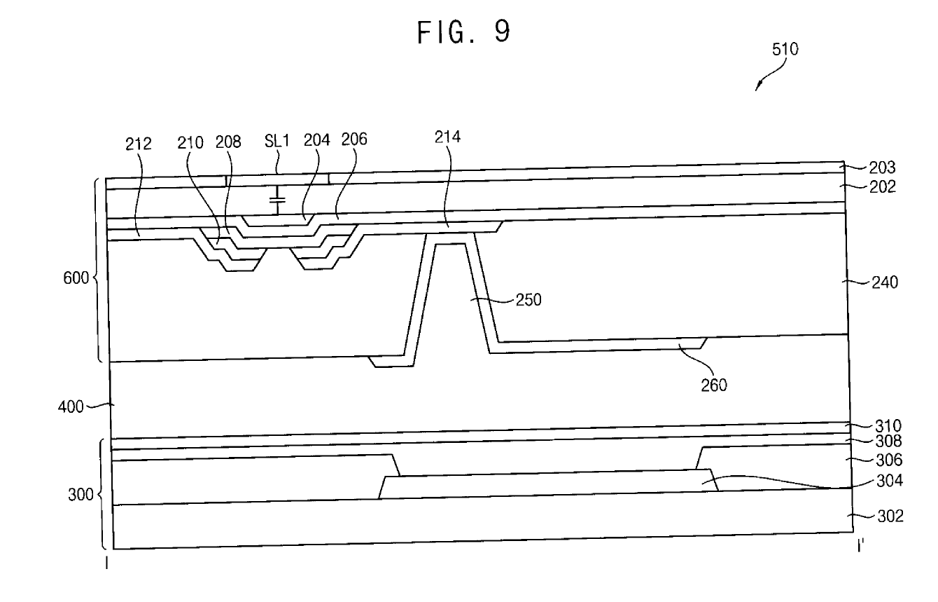

FIG. 9 is a cross-sectional view illustrating the display panel 510 of FIG. 8.

The display panel 510 of FIG. 9 is substantially the same as the display panel 110 of FIG. 3 except for a first substrate 600. Thus, the same reference numerals will be used to refer to same or like parts as those described in the previous exemplary embodiment and any further repetitive explanation concerning the above elements will be omitted.

Referring to FIGS. 8 and 9, the display panel 510 includes the first substrate 600, the second substrate 300, and the liquid crystal layer 400.

The first substrate 600 includes the first base substrate 202, the thin-film transistor 230 formed on a first surface of the first base substrate 202, the sense line layer 203 formed on a is second surface opposite to the first surface of the first base substrate 202 and having the first sense line SL1, the organic insulating layer 240 formed on the thin-film transistor 230. the pixel electrode 260 formed on the organic insulating layer 240 and electrically connected with the drain electrode 214 of the thin-film transistor 230 through the contact hole 250 formed through the organic insulating layer 240.

The first base substrate 202 is disposed between the gate lines GL1, GL2, . . . , GLN and the first and second sense lines SL1 and SL2. Thus, the first sense line SL1 and the first gate line GL1 or the first sense line SL1 and the gate electrode 204 forms a capacitance. When the first substrate 600 is touched, the capacitance between the first sense line SL1 and the first gate line GL1 is changed, and thus the display panel 510 including the first substrate 600 may sense a touch.

In the present exemplary embodiment, the first base substrate 202 is formed between the gate electrode 204 and the first sense line SL1 of the display panel 510, but it is not limited thereto. For example, in the display panel 510 the sense line layer 203 may be formed on the first base substrate 202, and the insulating layer 220 may be formed between the gate electrode 204 and the first sense line SL1 in the same manner as FIG. 3.

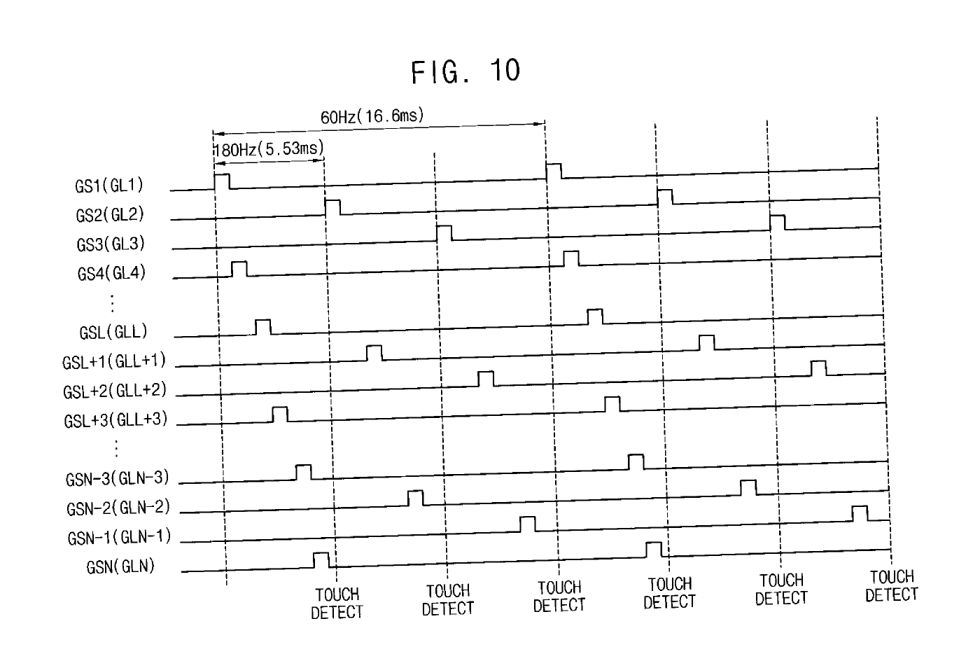

FIG. 10 is a waveform diagram illustrating the gate signals applied to the gate lines GL1, GL2, . . . , GLN of FIG. 8.

Referring to FIGS. 8 and 10, the gate lines GL1, GL2, . . . , GLN are driven per three gate lines. Specifically, the first gate line group GL1, GL4, . . . , GLN−3 and GLN spaced apart from each other per three gate lines, the second gate line group GL2, GL5, . . . , GLN−2 spaced apart from each other per three gate lines and adjacent to the first gate line group GL1, GL4, . . . , GLN−3 and GLN, and third gate line group GL3, GL6, . . . , GLN−1 spaced apart from is each other and adjacent to the second gate line group GL2, GL5, . . . , GLN−2 are sequentially driven. When a frame frequency of the image data DATA is about 60 Hz, the gate lines GL1, GL2, . . . , GLN are driven at a frequency of about 60 Hz. Thus, a driving frequency of the display panel 510 is about 60 Hz, and a driving period of the gate liens GL1, GL2, . . . , GLN is about 16.6 ms.

When the first gate line group GL1, GL4, . . . , GLN−3 and GLN is driven, the display panel 510 may sense the touch because the first sense line SL1 overlaps with the first gate line group GL1, GL4, . . . , GLN−3 and GLN. When the second gate line group GL2, GL5, . . . , GLN−2 is driven, the display panel 510 may sense the touch because the second sense line SL2 overlaps with the second gate line group GL2, GL5, . . . , GLN−2. When the third gate line group GL3, GL6, . . . , GLN−1 is driven, the display panel 510 may sense the touch because the third sense line SL3 overlaps with the third gate line group GL3, GL6, . . . , GLN−1.

When the gate lines GL1, GL2, . . . , GLN are driven, the display panel 510 senses the touch three times, and thus the display panel 510 may sense the touch in a frequency of about 180 Hz. Thus, a touch sense frequency of the display panel 510 is about 180 Hz, and a touch sense period of the display panel 510 is about 5.53 ms.

In the present exemplary embodiment, each of the touch cells 511 includes three sense lines SL1, SL2 and SL3, and the gate lines GL1, GL2, . . . , GLN are driven per three gate lines, but it is not limited thereto. For example, each of the touch cells 511 may include A (A is a natural number greater than two) numbers of the sense lines, and the gate lines GL1, GL2, . . . , GLN may be driven per A of the gate lines.

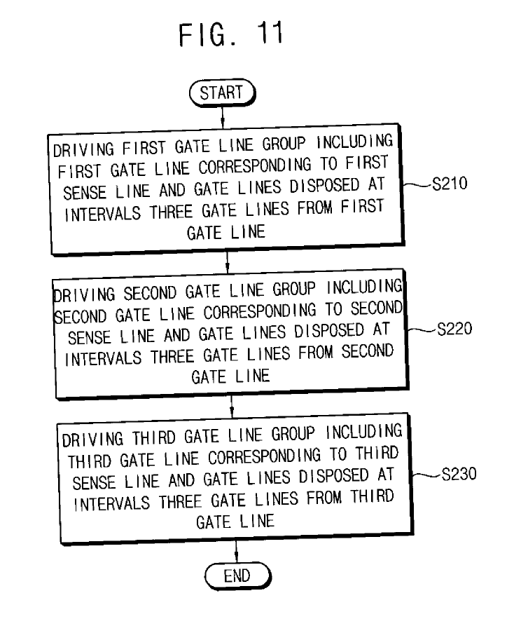

FIG. 11 is a flow chart illustrating a method of a driving a display panel driving the display panel 510 of FIG. 8.

Referring to FIGS. 8 to 11, the first gate line group GL1, GL4, . . . , GLN−3 and GLN including the first gate line GL1 corresponding to the first sense line SL1 and gate lines GL4, GL7, . . . , GLN−3 and GLN disposed at intervals of three gate lines from the first gate line GL1 is driven (step S210). When the first gate line group GL1, GL4, . . . , GLN−3 and GLN is driven, the display panel 510 may sense the touch because the first sense line SL1 overlaps with the first gate line group GL1, GL4, . . . , GLN−3.

The second gate line group GL2, GL5, . . . , GLN−2 including the second gate line GL2 corresponding to the second sense line SL2 and gate lines GL5, GL8, . . . , GLN−2 disposed at intervals of three gate lines from the second gate line GL2 is driven (step S220). The second gate line group GL2, GL5, . . . , GLN−2 is driven, the display panel 510 may sense the touch because the second sense line SL2 overlaps with the second gate line group GL2, GL5, . . . , GLN−2.

The third gate line group GL3, GL6, . . . , GLN−1 including the third gate line GL3 formed correspondingly to the third sense line SL3 and gate lines GL6, GL9, . . . , GLN−1 disposed at intervals of three gate lines from the third gate line GL3 is driven (step S230). When the third gate line group GL3, GL6, . . . , GLN−1 is driven, the display panel 510 may sense the touch because the third sense line SL3 overlaps with the third gate line group GL3, GL6, . . . , GLN−1.

According to the present exemplary embodiment, each of the touch cells 511 includes the first sense line SL1, the second sense line SL2, and the third sense line SL3 respectively overlapping with the gate lines adjacent to each other, the gate lines GL1, GL2, . . . , GLN are driven per three gate lines, and thus the touch sense frequency of the display panel 510 is three times the driving frequency of the display panel 510. Thus, a touch sense rate of the is display panel 510 may be increased.

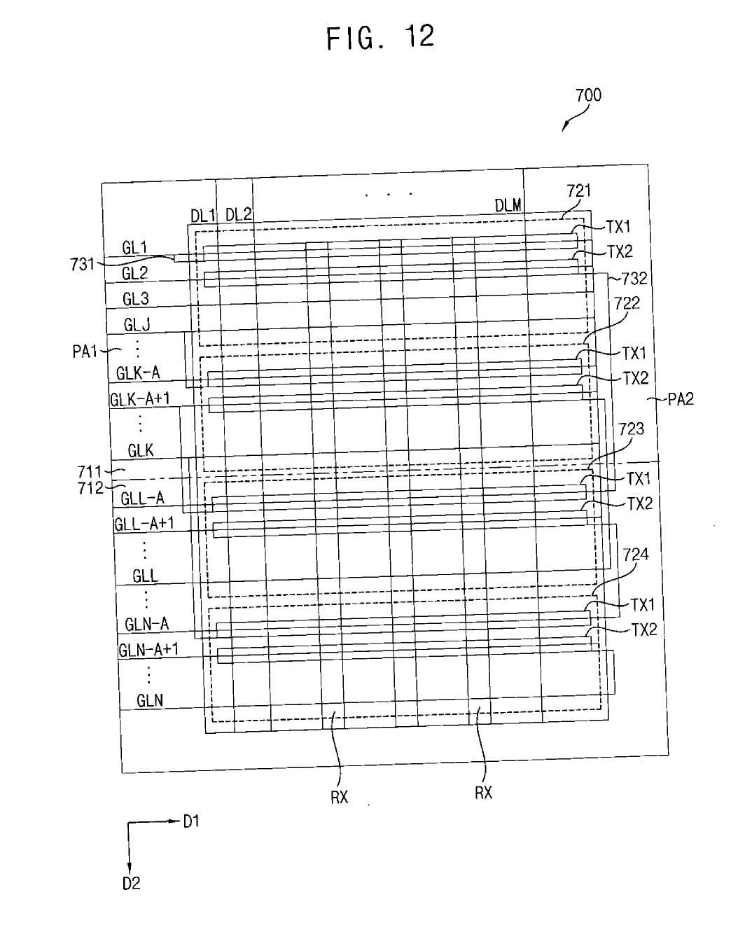

FIG. 12 is a plan view illustrating a display panel according to still another exemplary embodiment of the present invention.

Referring to FIG. 12, the display panel 700 according to the present exemplary embodiment includes gate lines GL1, GL2, . . . , GLN substantially parallel with a first direction D1, data lines DL1, DL2, . . . , DLM substantially parallel with a second direction D2 substantially perpendicular to the first direction D1, and a plurality of pixels.

The display panel 700 includes a display area DA and peripheral areas PA1 and PA2 peripheral to the display area DA and having a light shielding layer such as a black matrix (not shown). The peripheral areas PA1 and PA2 include a first peripheral area PA1 adjacent to a first terminal of the gate lines GL1, GL2, . . . , GLN, and a second peripheral area PA2 adjacent to a second terminal of the gate lines GL1, GL2, . . . , GLN.

In addition, the display panel 700 includes a first area 711 and a second area 712 divided based on a number of the gate lines GL1, GL2, . . . , GLN. For example, when the number of the gate lines GL1, GL2, . . . , GLN is about 800, the first area 711 may include about 400 gate lines GL1, GL2, . . . , GLK and the second area 712 may include about 400 gate lines GLL−A, GLL−A+1, . . . , GLN. The gate lines GL1, GL2, . . . , GLK disposed in the first area 711 may be first area gate lines and the gate lines GLL−A, GLL−A+1, . . . , GLN disposed in the second area 712 may be second area gate lines.

The display panel 700 includes a plurality of touch cells 721, 722, 723, and 724. For example, the display panel 700 includes a first touch cell 721, a P-th (P is a natural number greater than 2) touch cell 722, a Q-th (Q is a natural number greater than P) touch cell 723 and an R-th (R is a natural number greater than Q) touch cell 724. In addition, the first touch cell 721 to is the P-th touch cell 722 may be disposed in the first area 711 and the Q-th touch cell 723 to the R-th touch cell 724 may be disposed in the second area 712.

Gate lines may be disposed in each of the touch cells 721, 722, 723, and 724. For example, when the number of the gate lines GL1, GL2, . . . , GLN is about 800, the display panel 700 may include 40 touch cells 721, 722, 723, and 724, and 20 gate lines may be disposed in each of the touch cells 721, 722, 723, and 724.

Each of the touch cells 721, 722, 723, and 724 includes a first transmit line TX1 and a second transmit line TX2. In addition, the display panel 700 includes a plurality of receive lines RX extending in the second direction D2 substantially perpendicular to the first direction D1 in which the first transmit line TX1 and the second transmit line TX2 extend.

One of the first transmit line TX1 and the second transmit line TX2 and one of the receive lines RX forms a capacitance, and the capacitance is changed by a touch on the display panel 700. Thus, the display panel 700 may sense the touch.

The first transmit line TX1 and the second transmit line TX2 are adjacent to each other. The first transmit line TX1 and the second transmit line TX2 are respectively connected with gate lines disposed in areas different from each other. For example, the first transmit line TX1 is connected with gate lines GL1, GLJ, GLK−A, and GLK disposed in the first area 711, and the second transmit line TX2 is connected with gate lines GLL−A, GLL, GLN−A, and GLN disposed in the second area 712.

Specifically, the first transmit line TX1 of the first touch cell 721 may be connected with the first gate line GL1, the first transmit line TX1 of the P-th touch cell 722 may be connected with a J-th (J is a natural number greater than 2) gate line GLJ, the first transmit line TX1 of the Q-th touch cell 723 may be connected with a (K−A)-th (K is a natural number is greater than J and A is a natural number) gate line GLK−A, and the first transmit line TX1 of the R-th touch cell 724 may be a K-th gate line GLK.

In addition, the second transmit line TX2 of the first touch cell 721 may be connected with an (L−A)-th (L is a natural number greater than K) gate line GLL−A, the second transmit line TX2 of the P-th touch cell 722 may be connected with an L-th gate line GLL, the second transmit line TX2 of the Q-th touch cell 723 may be connected with an (N−A)-th (N is a natural number greater than L) gate line GLN−A, and the second transmit line TX2 of the R-th touch cell 724 may be an N-th gate line GLN.

The first transmit lines TX1 are connected with the gate lines GL1, GLJ, GLK−A, and GLK disposed in the first area 711 through first connection lines 731 in the first peripheral area PA1, and the second transmit lines TX2 are connected with the gate lines GLL−A, GLL, GLN−A, and GLN disposed in the second area 712 through second connection lines 732 in the second peripheral area PA2. Thus, a short circuit between the first connection line 731 and the second connection line 732 may be prevented.

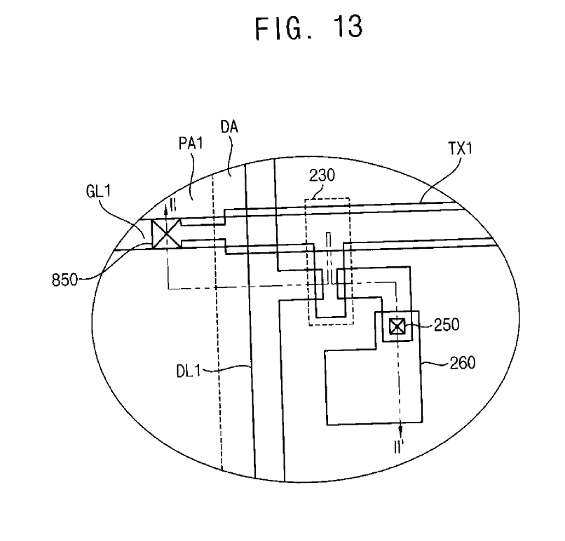

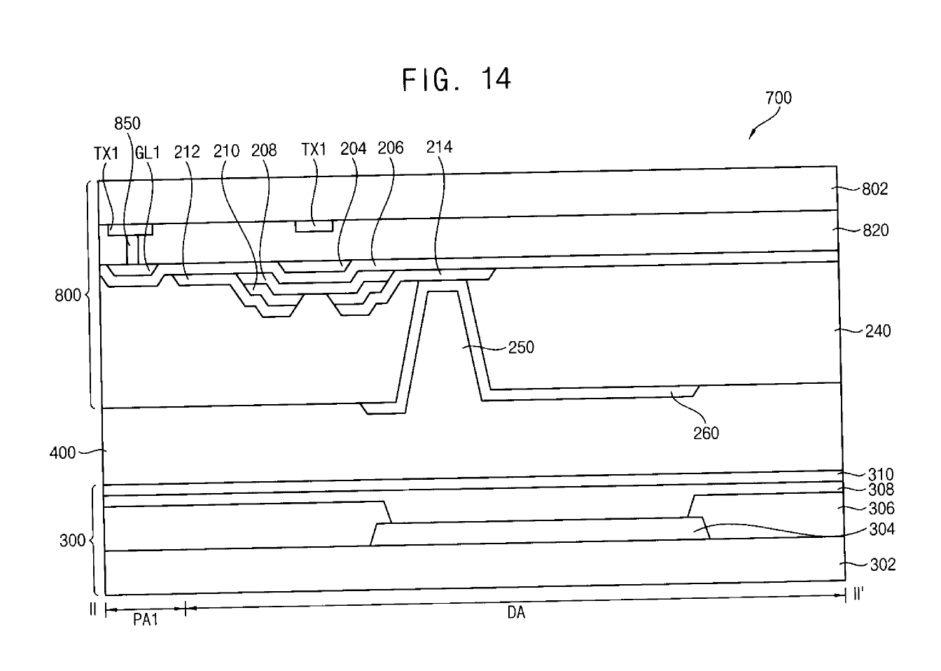

FIG. 13 is a plan view illustrating a portion of the display panel 700 of FIG. 12, and FIG. 14 is a cross-sectional view taken along a line II-II′ of FIG. 13.

The display panel 700 of FIG. 14 is substantially the same as the display panel 110 of FIG. 3 except for a first substrate 800. Thus, the same reference numerals will be used to refer to same or like parts as those described in the previous exemplary embodiment and any further repetitive explanation concerning the above elements will be omitted.

Referring to FIGS. 13 and 14, the display panel 700 includes the first substrate 800, the second substrate 300, and the liquid crystal layer 400.

The first substrate 800 includes a first base substrate 802 having the display area DA and the first peripheral area PA1, a touch sense layer 820 formed on the first base substrate 802, including an insulating material and having the first transmit line TX1, the first gate line GL1 and the thin-film transistor 230 formed on the touch sense layer 820 and electrically connected with the first transmit line TX1 in the first peripheral area PA1 through a contact hole 850 formed through the touch sense layer 820, the organic insulating layer 240 formed on the thin-film transistor 230, and the pixel electrode 260 formed on the organic insulating layer 240 and electrically connected with the drain electrode 214 of the thin-film transistor 230 through the contact hole 250 formed through the organic insulating layer 240.

The touch sense line 820 further includes the second transmit line TX2 and the receive line RX.

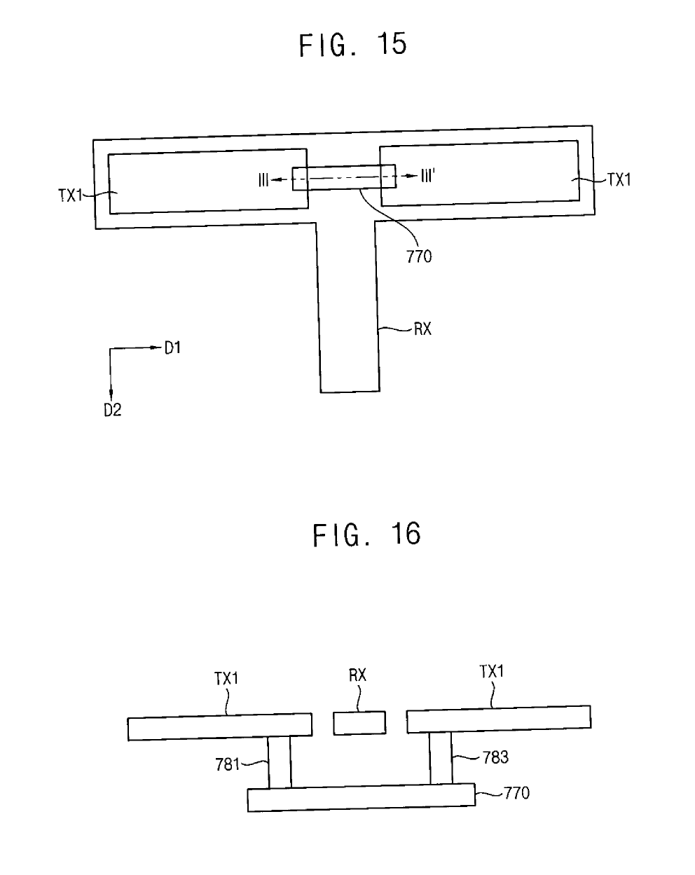

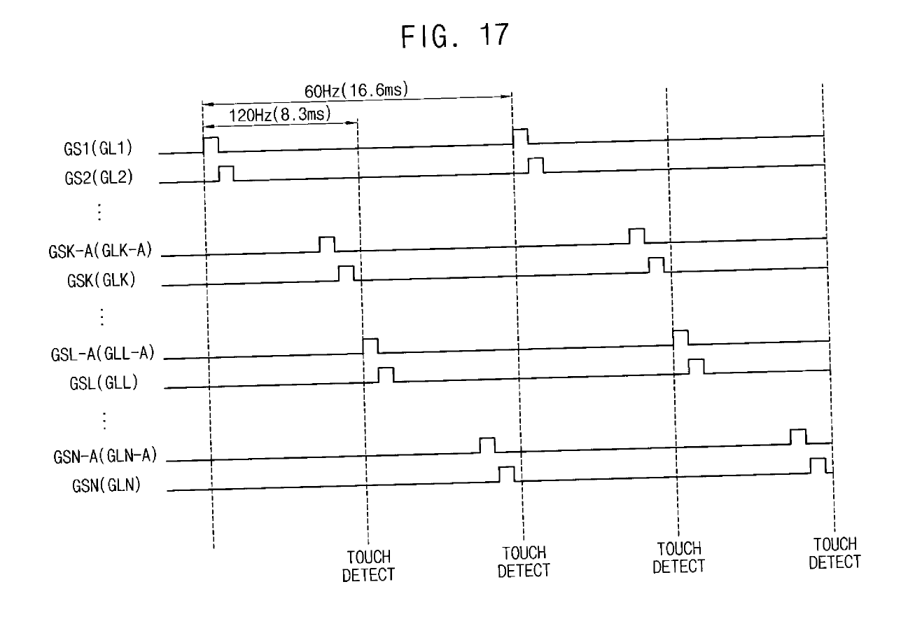

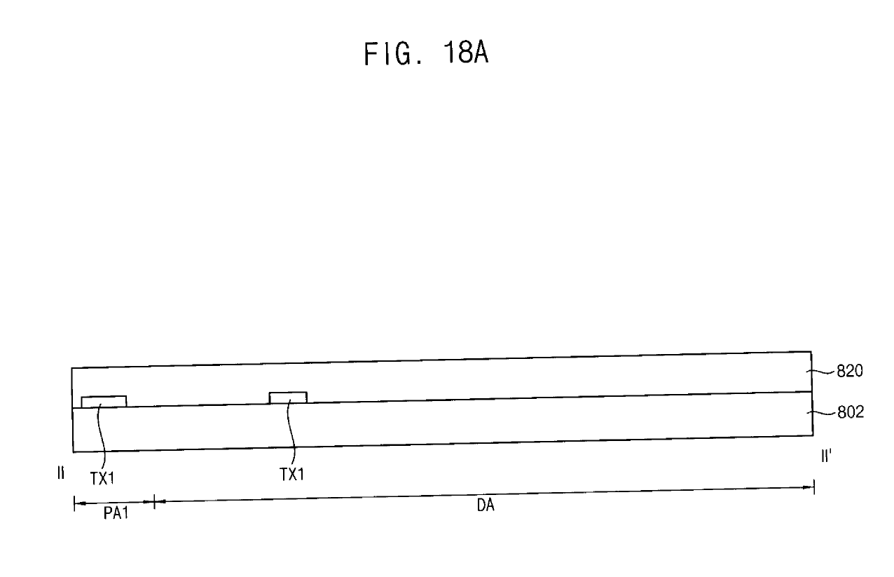

FIG. 15 is an enlarged view illustrating the first transmit line TX1 and the receive line RX of FIG. 12, and FIG. 16 is a cross-sectional view taken along a line III-III′ of FIG. 15.

Referring to FIGS. 12, 15, and 16, the first transmit line TX1 is covered by the receive line RX. In addition, the first transmit line TX1 is cut by an extension of the receive line RX in the second direction D2, and the cut first transmit line TX1 is connected by a bridge line 770 and contact holes 781 and 783. For example, the bridge line 770 may be disposed on the same layer as the gate lines GL1, GL2, . . . , GLN, and may be formed in the same process as the gate lines GL1, GL2, . . . , GLN.

In the present exemplary embodiment, a shape of the first transmit line TX1 is flat and linear, and a shape of the receive line RX is flat and linear, but the present invention is not limited thereto. For example, each of the shapes of the first transmit line TX1, the second transmit line TX2, and the receive line RX may be linear, quadrangle, diamond, hexagon, arrow shape, a combination thereof, etc.

FIG. 17 is a waveform diagram illustrating gate signals applied to the gate lines GL1, GL2, . . . , GLN of FIG. 12.

Referring to FIGS. 12 and 17, the gate lines GL1, GL2, . . . , GLN are sequentially driven. When a frame frequency of an image data displayed on the display panel 700 is about 60 Hz, the gate lines GL1, GL2, . . . , GLN are driven at a frequency of about 60 Hz. Thus, a driving frequency of the display panel 700 is about 60 Hz, and a driving period of the gate lines GL1, GL2, . . . , GLN is about 16.6 ms.

When the gate lines GL1, GL2, . . . , GLK in the first area 711 are driven, the first transmit lines TX1 of the touch cells 721, 722, 723, and 724 are driven, and the display panel 700 may sense the touch. In addition, when the gate lines GLL−A, . . . , GLN in the second area 712 are driven, the second transmit lines TX2 of the touch cells 721, 722, 723, and 724 are driven, and the display panel 700 may sense the touch. Therefore, when the display panel 700 is driven, the display panel 700 senses the touch twice, and thus a touch sense frequency of the display panel 700 is about 120 Hz, and a touch sense period of the display panel 700 is about 8.3 MS.

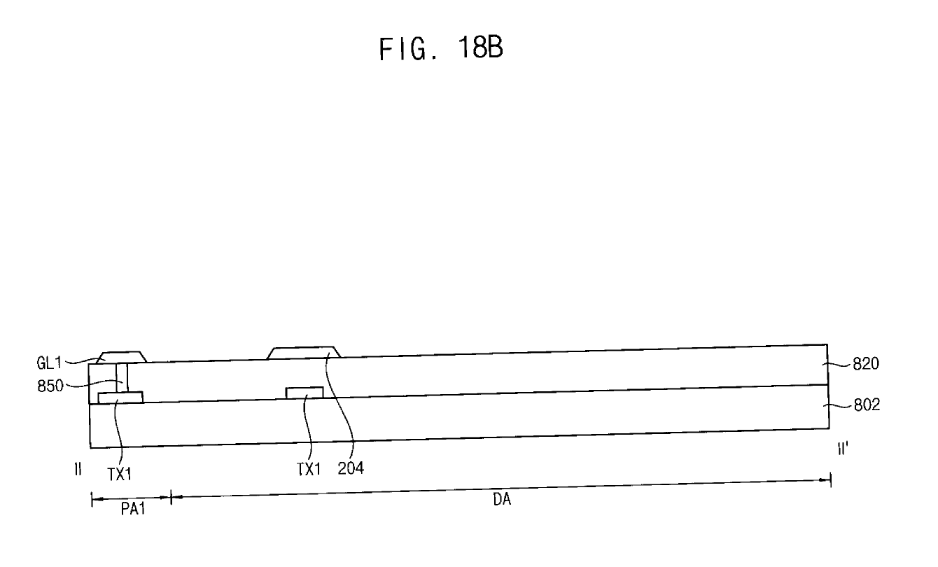

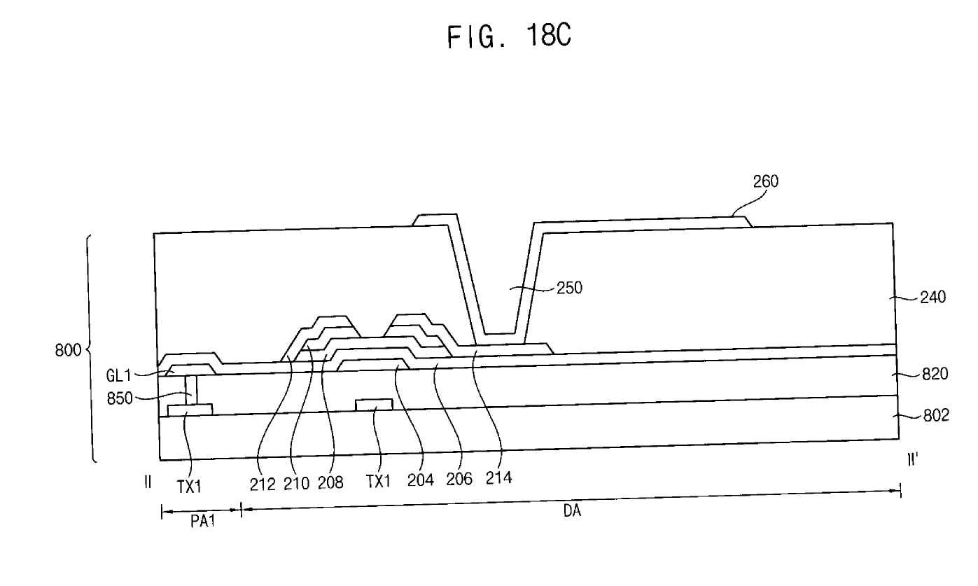

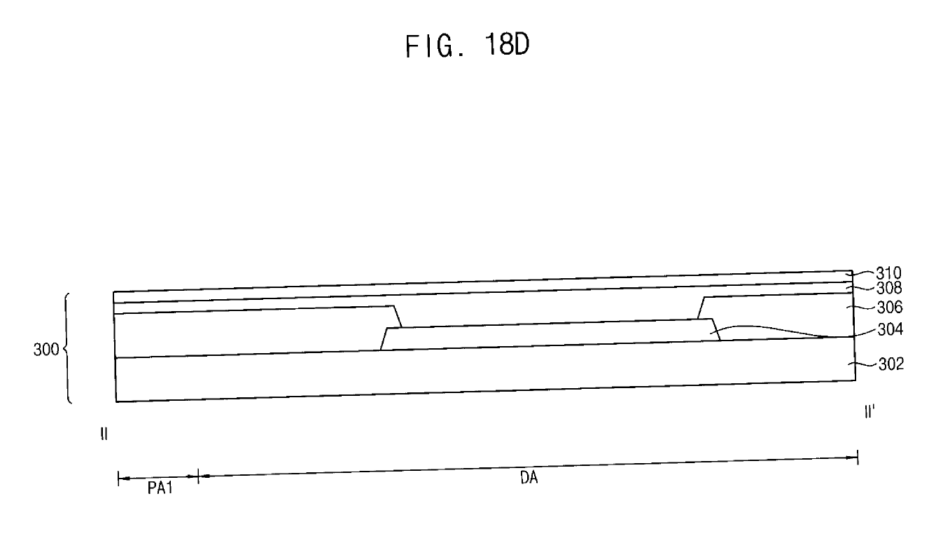

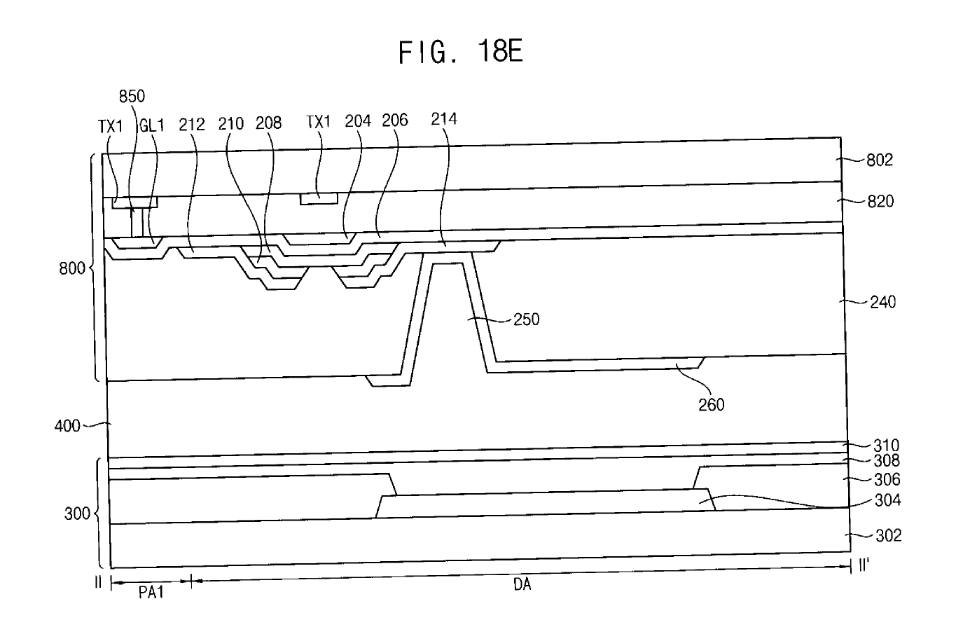

FIGS. 18A to 18E are cross-sectional views illustrating a method of manufacturing the display panel 700 of FIG. 14.

Referring to FIG. 18A, the touch sense layer 820 is formed on the first base substrate 802. The first base substrate 802 includes the display area DA and the first peripheral area PA1. In addition, the first base substrate 802 further includes the second peripheral area PA2 facing the first peripheral area PA1. The touch sense layer 820 includes the first transmit line TX1. In addition, the touch sense layer 820 further includes the second transmit line TX2 and the receive line RX.

Referring to FIG. 18B, the first gate line GL1 and the gate electrode 204 are formed on the touch sense layer 820. The first gate line GL1 is electrically connected with the first transmit line TX1 through the contact hole 850 formed through the touch sense layer 820.

Referring to FIG. 18C, the gate insulating layer 206, the active layer 208, the ohmic-contact layer 210, the source electrode 212 and the drain electrode 214 form the thin-film transistor 230. The organic insulating layer 240 is formed on the thin-film transistor 230 and the pixel electrode 260 electrically connected with the drain electrode 214 of the thin-film transistor 230 through the contact hole 250 formed through the organic insulating layer 240 is formed on the organic insulating layer 240 to form the first substrate 800.

Referring to FIG. 18D, the second substrate 300 is formed. Specifically, the color filter 304 is formed on the second base substrate 302, the light shielding layer 306 is formed on the color filter 304, the over-coating layer 308 is formed on the light shielding layer 306, and the common electrode 310 is formed on the over-coating layer 308.

Referring to FIG. 18E, the first substrate 800 and the second substrate 300 are combined with each other, and the liquid crystal layer 400 is interposed between the first substrate 800 and the second substrate 300.

According to the present exemplary embodiment, each of the touch cells 721, 722, 723, and 724 includes the first transmit line TX1 connected with one of the gate lines GL1, GL2, . . . , GLK disposed in the first area 711 and the second transmit line TX2 connected with one of the gate lines GLL−A, . . . , GLN disposed in the second area 712, and thus the touch sense frequency of the display panel 700 is twice the driving frequency of the display panel 700. Thus, a touch sense rate of the display panel 700 may be increased.

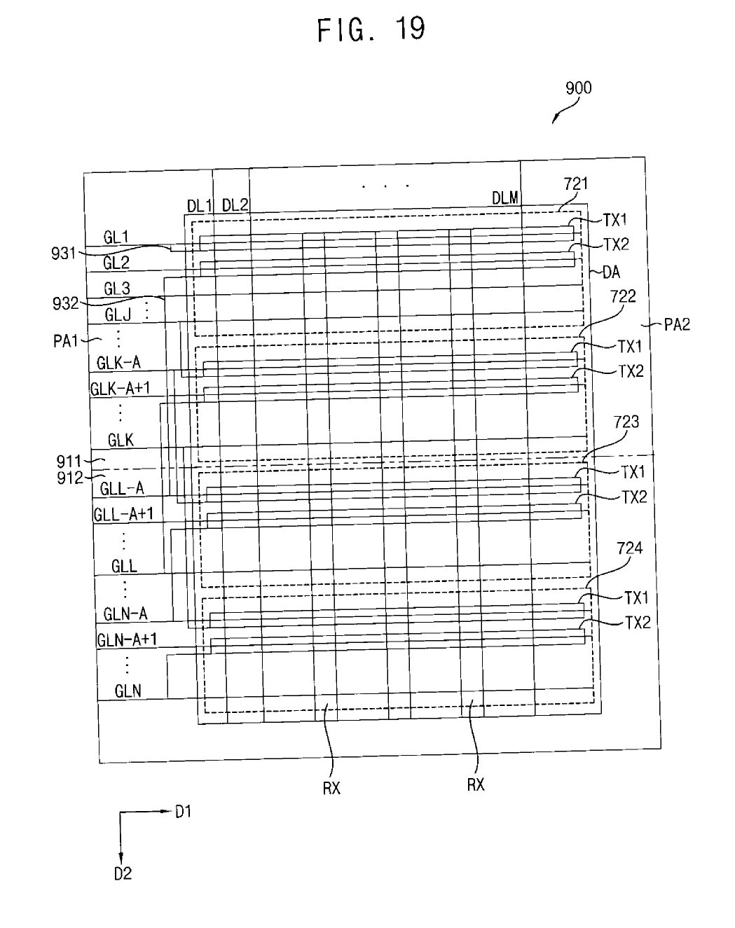

FIG. 19 a plan view illustrating a display panel according to still another is exemplary embodiment of the present invention.

The display panel 900 according to the present exemplary embodiment is substantially the same as the display panel 700 according to the previous exemplary embodiment illustrated in FIG. 12 except for a position of a connection between the second transmit line TX2 and the gate lines GLL−A, GLL, GLN−A and GLN. Thus, the same reference numerals will be used to refer to same or like parts as those described in the previous exemplary embodiment, and any further repetitive explanation concerning the above elements will be omitted.

The display panel 900 includes a first area 911 and a second area 912 divided based on the number of the gate lines GL1, GL2, . . . , GLN. The gate lines GL1, GL2, . . . , GLK disposed in the first area 911 may be first area gate lines and the gate lines GLL−A, GLL−A+1, . . . , GLN disposed in the second area 912 may be second area gate lines.

The first transmit lines TX1 are connected with the gate lines GL1, GLJ, GLK−A and GLK disposed in the first area 911 through first connection lines 931 in the first peripheral area PA1, and the second transmit lines TX2 are connected with the gate lines GLL−A, GLL, GLN−A and GLN disposed in the second area 912 through second connection lines 932 in the first peripheral area PA1.

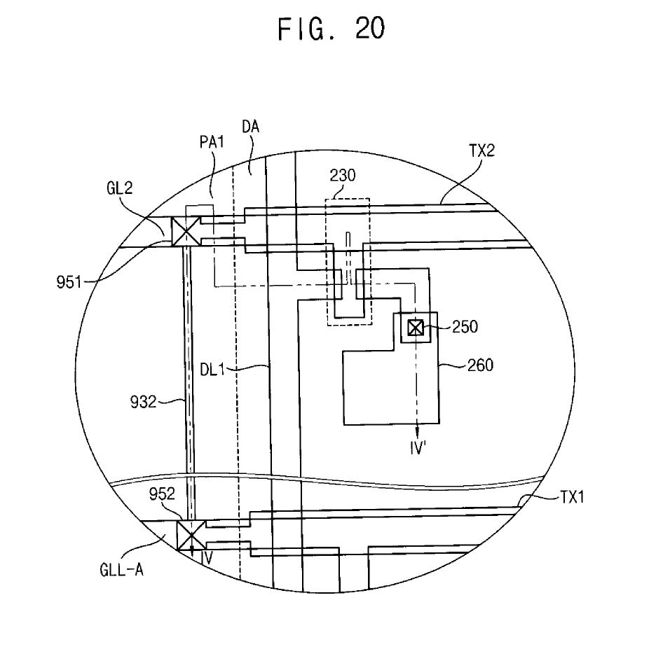

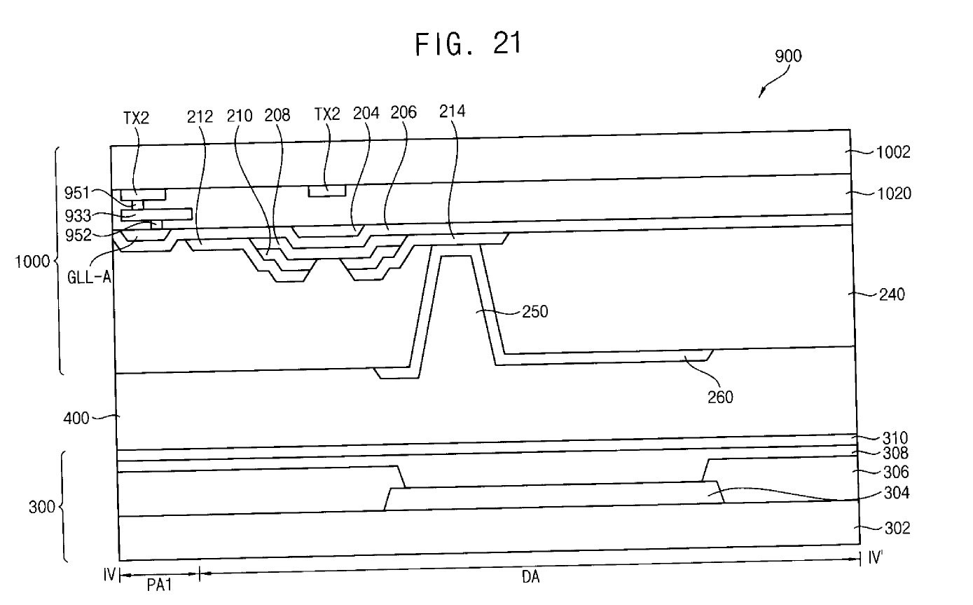

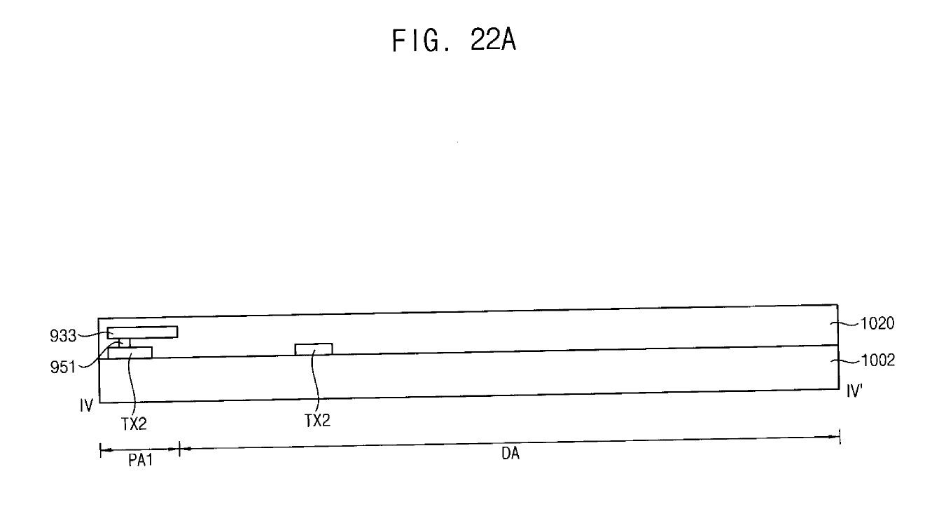

FIG. 20 is a plan view illustrating a portion of the display panel 900 of FIG. 19, and FIG. 21 is a cross-sectional view taken along a line IV-IV′ of FIG. 20.

The display panel 900 of FIG. 21 is substantially the same as the display panel 700 of FIG. 14 except for a first substrate 1000. Thus, the same reference numerals will be used to refer to same or like parts as those described in the previous exemplary embodiment, and any further repetitive explanation concerning the above elements will be omitted.

Referring to FIGS. 20 and 21, the display panel 900 includes the first substrate 1000, the second substrate 300, and the liquid crystal layer 400.

The first substrate 1000 includes a first base substrate 1002 including the display area DA and the first peripheral area PA1, a touch sense layer 1020 formed on the first base substrate 1002 and having the second transmit line TX2, the (L−A)-th gate line GLL−A and the thin-film transistor 230 formed on the touch sense layer 1020 and connected with the second transmit line TX2, the organic insulating layer 240 formed on the thin-film transistor 230, and the pixel electrode 260 formed on the organic insulating layer 240 and electrically connected with the drain electrode 214 of the thin-film transistor 230 through the contact hole 250 formed through the organic insulating layer 240.

The touch sense layer 1020 includes a connection line layer 933 having the second connection line 932 connecting the second transmit line TX2 with the (L−A)-th gate line GLL−A formed on a layer different from the first connection line 931. Thus, the first connection line 931 and the second connection line 932 are insulated from each other, although the first connection line 931 and the second connection line 932 are disposed in the first peripheral area PA1.

The second transmit line TX2 is connected to the second connection line 932 and the connection line layer 933 through a contact hole 951, and the second connection line 932 and the connection line layer 933 are connected with the (L−A)-th gate line GLL−A through a contact hole 952.

The touch sense layer 1020 further includes the first transmit line TX1 and the receive line RX.

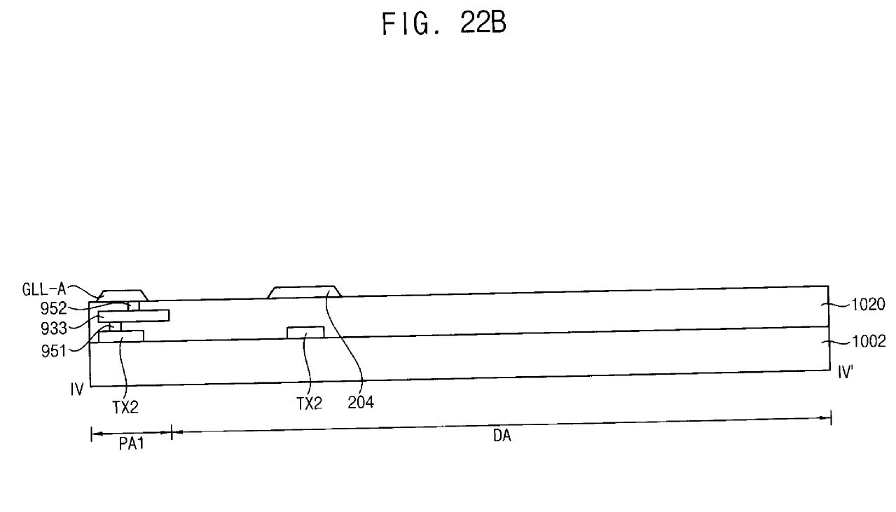

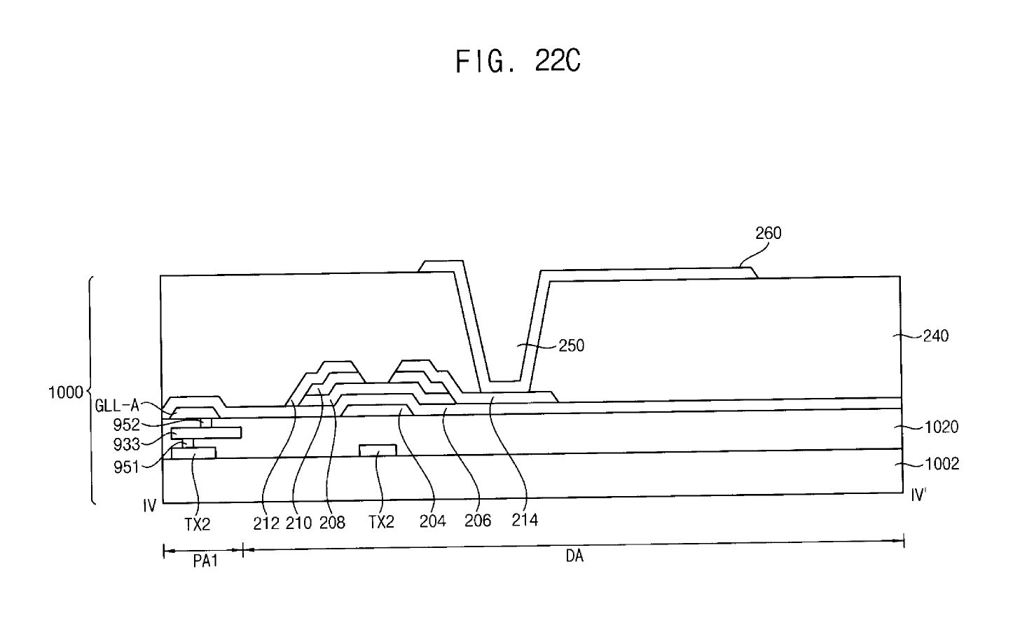

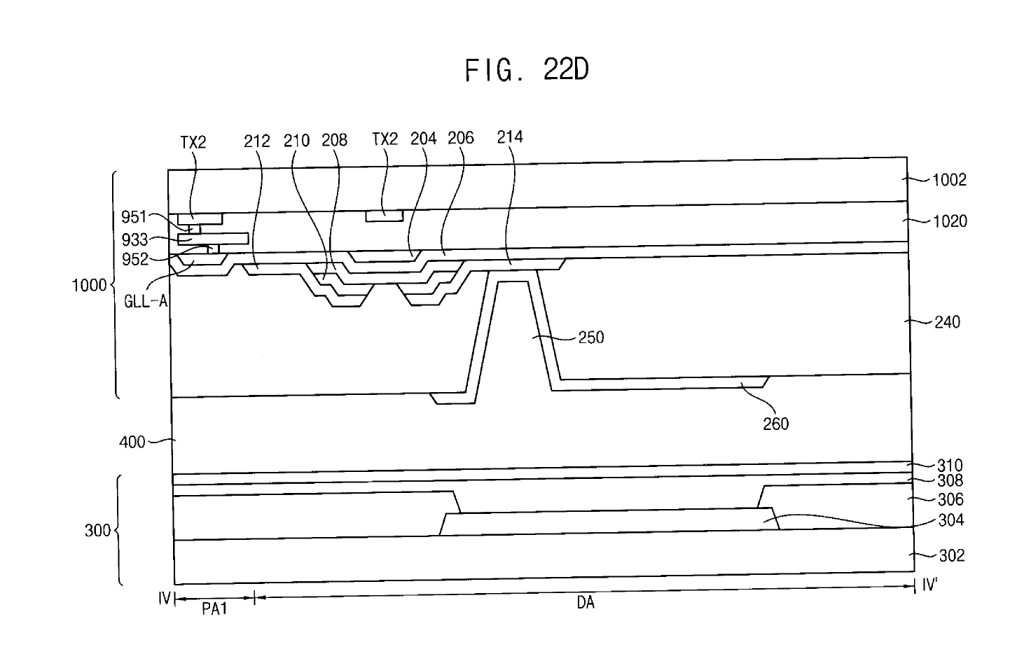

FIGS. 22A to 22D are cross-sectional views illustrating a method of manufacturing the display panel 900 of FIG. 21.

Referring to FIG. 22A, the touch sense layer 1020 is formed on the first base substrate 1002. The first base substrate 1002 includes the display area DA and the first peripheral area PA1. In addition, the first base substrate 1002 may further include the second peripheral area PA2 facing the first peripheral area PA1. The touch sense layer 1020 includes the second transmit line TX2 and the connection line layer 933. The second connection line 932 connected with the second transmit line TX2 through the contact hole 951 is formed on the connection line layer 933. In addition, the touch sense layer 1020 further includes the first transmit line TX1 and the receive line RX.

Referring to FIG. 22B, the (L−A)-th gate line GLL−A and the gate electrode 204 are formed on the touch sense layer 1020. The (L−A)-th gate line GLL−A is connected to the second connection line 932 and the connection line layer 933 through the contact hole 952 formed through the touch sense layer 1020.

Referring to FIG. 22C, the gate insulating layer 206, the active layer 208, the ohmic-contact layer 210, the source electrode 212 and the drain electrode 214 are formed to form the thin-film transistor 230. The organic insulating layer 240 is formed on the thin-film transistor 230 and the pixel electrode 260 electrically connected with the drain electrode 214 of the thin-film transistor 230 through the contact hole 250 formed through the organic insulating layer 240 is formed on the organic insulating layer 240 to form the first substrate 1000.

Referring to FIG. 22D, the second substrate 300 is formed, the first substrate 1000 and the second substrate 300 are combined with each other, and the liquid crystal layer 400 is interposed between the first substrate 1000 and the second substrate 300. The method of manufacturing the second substrate 300 is substantially the same as the method of manufacturing the second substrate 300 described with reference to FIG. 18D. Thus, any further repetitive is explanation concerning the above elements will be omitted.

According to the present exemplary embodiment, the first transmit line TX1 and the second transmit line TX2 in each of the touch cells 721, 722, 723, and 724 are connected with the gate lines GL1, GLJ, GLK−A, GLK, GLL−A, GLL, GLN−A, and GLN in the first peripheral area PA1, and thus a width of a bezel of a display apparatus including the display panel 900 may be decreased.

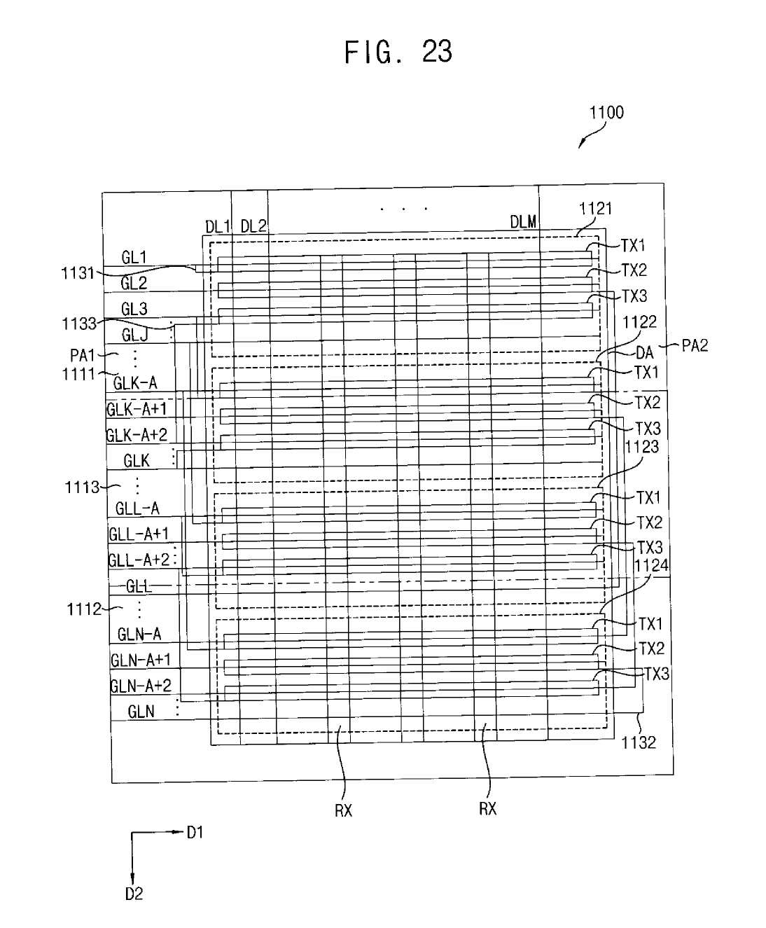

FIG. 23 is a plan view illustrating a display panel according to still another exemplary embodiment of the present invention.

Referring to FIG. 23, the display panel 1100 according to the present exemplary embodiment includes gate lines GL1, GL2, . . . , GLN substantially parallel with a first direction D1, data lines DL1, DL2, . . . , DLM substantially parallel with a second direction D2 substantially perpendicular to the first direction D1, and a plurality of pixels.

The display panel 1100 includes a display area DA and peripheral areas PA1 and PA2 peripheral to the display area DA and having a light shielding layer such as a black matrix. The peripheral areas PA1 and PA2 includes a first peripheral area PA1 adjacent to a first terminal of the gate lines GL1, GL2, . . . , GLN, and a second peripheral area PA2 adjacent to a second terminal of the gate lines GL1, GL2, . . . , GLN.

In addition, the display panel 1100 includes a first area 1111, a second area 1112, and a third area 1113 divided based on a number of the gate lines GL1, GL2, . . . , GLN. For example, when the number of the gate lines GL1, GL2, . . . , GLN is about 780, the first area 1111 may include about 260 gate lines GL1, GL2, . . . , GLK−A, the second area 1112 may include about 260 gate lines GLL, . . . , GLN, and the third area 1113 may include about 260 gate lines GLK−A+1, GLK−A+2, . . . , GLL−A+1 and GLL−A+2. The gate lines GL1, GL2, . . . , GLK−A is disposed in the first area 1111 may be first area gate lines, the gate lines GLL, . . . , GLN disposed in the second area 1112 may be second area gate lines, and the gate lines GLK−A+1, GLK−A+2, . . . , GLL−A+1 and GLL−A+2 disposed in the third area 1113 may be third area gate lines.

The display panel 1100 includes a plurality of touch cells 1121, 1122, 1123, and 1124. For example, the display panel 1100 includes a first touch cell 1121, an S-th (S is a natural number greater than 2) touch cell 1122, a T-th (T is a natural number greater than S) touch cell 1123, and a U-th (U is a natural number greater than T) touch cell 1124.

Each of the touch cells 1121, 1122, 1123, and 1124 includes a first transmit line TX1, a second transmit line TX2, and a third transmit line TX3. In addition, the display panel 1100 includes a plurality of receive lines RX extending in the second direction D2 substantially perpendicular to the first direction D1 in which the first transmit line TX1, the second transmit line TX2, and the third transmit line TX3 extend.

One of the first transmit line TX1, the second transmit line TX2, and the third transmit line TX3 and one of the receive lines RX forms a capacitance, and the capacitance is changed by a touch on the display panel 1100. Thus, the display panel 1100 may sense the touch.

The first transmit line TX1, the second transmit line TX2, and the third transmit line TX3 are adjacent to each other. The first transmit line TX1, second transmit line TX2, and the third transmit line TX3 are respectively connected with gate lines disposed in areas different from each other. For example, the first transmit line TX1 is connected with gate lines GL1, GL3, GLJ, and GLK−A disposed in the first area 1111, the second transmit line TX2 is connected with gate lines GLL, GLN−A, GLN−A+2, and GLN disposed in the second area 1112, and the third transmit line TX3 is connected with gate lines GLK−A+2, GLK, GLL−A, and GLL−A+2 is disposed in the third area 1113.

Specifically, the first transmit line TX1 of the first touch cell 1121 may be connected with the a first gate line GL1, the first transmit line TX1 of the S-th touch cell 1122 may be connected with a third gate line GL3, the first transmit line TX1 of the T-th touch cell 1123 may be connected with a J-th (J is a natural number greater than 2) gate line GLJ, and the first transmit line TX1 of the U-th touch cell 1124 may be connected with a (K−A)-th (K is a natural number greater than J and A is a natural number) gate line GLK−A.

In addition, the second transmit line TX2 of the first touch cell 1121 may be connected with an L-th (L is a natural number greater than K) gate line GLL, the second transmit line TX2 of the S-th touch cell 1122 may be connected with an (N−A)-th (N is a natural number greater than L) gate line GLN−A, the second transmit line TX2 of the T-th touch cell 1123 may be connected with (N−A+2)-th gate line GLN−A+2, and the second transmit line TX2 of the U-th touch cell 1124 may be connected with an N-th gate line GLN.

In addition, the third transmit line TX3 of the first touch cell 1121 may be connected with a (K−A+2)-th gate line GLK−A+2, the third transmit line TX3 of the S-th touch cell 1122 may be connected with a K-th gate line GLK, the third transmit line TX3 of the T-th touch cell 1123 may be connected with an (L−A)-th gate line GLL−A, and the third transmit line TX3 of the U-th touch cell 1124 may be connected with an (L−A+2)-th gate line GLL−A+2.

The first transmit lines TX1 are connected with the gate lines GL1, GL3, GLJ, and GLK−A disposed in the first area 1111 through first connection lines 1131 in the first peripheral area PA1, the second transmit lines TX2 are connected with the gate lines GLL, GLN−A, GLN−A+2 and GLN disposed in the second area 1112 through second connection lines 1132 in the second peripheral area PA2, and the third transmit lines TX3 are connected with the gate is lines GLK−A+2, GLK, GLL−A and GLL−A+2 disposed in the third area 1113 through third connection lines 1133 in the first peripheral area PA1.

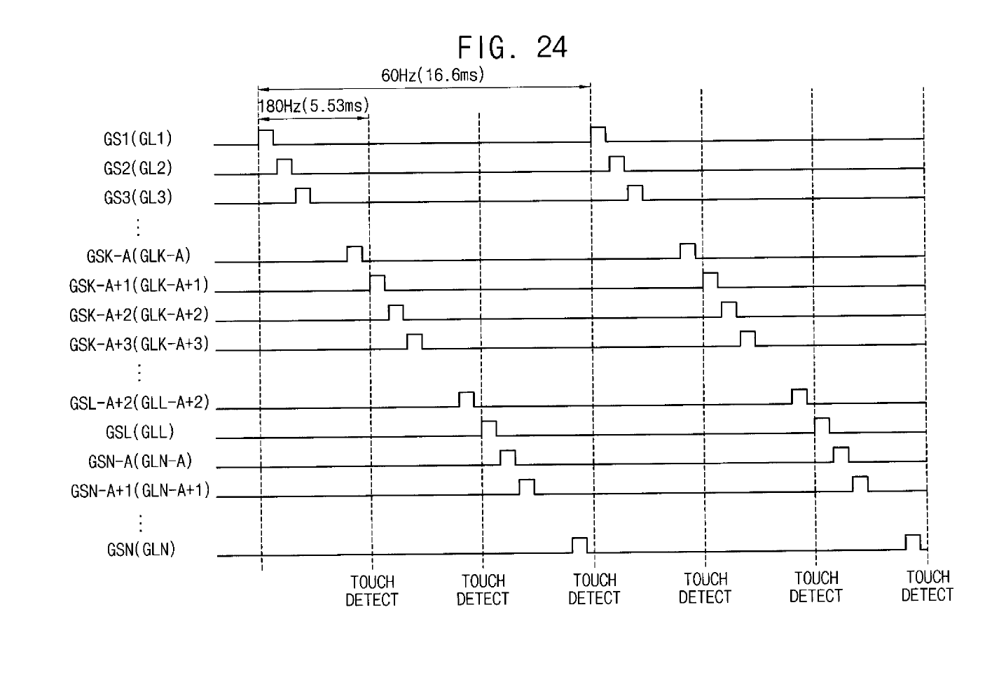

FIG. 24 is a waveform diagram illustrating gate signals applied to the gate lines GL1, GL2, . . . , GLN of FIG. 23.

Referring to FIGS. 23 and 24, the gate lines GL1, GL2, . . . , GLN are sequentially driven. When a frame frequency of an image data displayed on the display panel 1100 is about 60 Hz, the gate lines GL1, GL2, . . . , GLN are driven at a frequency of about 60 Hz. Thus, a driving frequency of the display panel 1100 is about 60 Hz, and a driving period of the gate lines GL1, GL2, . . . , GLN is about 16.6 ms.

The gate lines GL1, GL2, . . . , GLK−A in the first area 1111 are driven, the first transmit lines TX1 of the touch cells 1121, 1122, 1123, and 1124 are driven, and the display panel 1100 may sense the touch. In addition, when the gate lines GLK−A+1, . . . , GLL−A+2 in the third area 1113 are driven, the third transmit lines TX3 of the touch cells 1121, 1122, 1123, and 1124 are driven, and the display panel 1100 may sense the touch. In addition, when the gate lines GLL, . . . , GLN in the second area 1112 are driven, the second transmit lines TX2 of the touch cells 1121, 1122, 1123, and 1124 are driven, and the display panel 1100 may sense the touch. Therefore, when the display panel 1100 is driven, the display panel 1100 sense the touch three times, and thus a touch sense frequency of the display panel 1100 is about 180 Hz and a touch sense period of the display panel 1100 is about 5.53 ms.

A method of manufacturing the display panel 1100 is substantially the same as the method of manufacturing the display panel 900 described with reference to FIGS. 22A to 22D. Thus, any further repetitive explanation concerning the above elements will be omitted.

According to the present exemplary embodiment, each of the touch cells 1121, 1122, 1123, and 1124 includes the first transmit line TX1 connected with one of the gate lines GL1, . . . , GLK-A disposed in the first area 1111, the second transmit line TX2 connected with one of the gate lines GLL, . . . , GLN disposed in the second area 1112 and the third transmit line TX3 connected with one of the gate lines GLK−A+2, . . . , GLL−A+2 disposed in the third area 1113, and thus the touch sense frequency of the display panel 1100 is three times the driving frequency of the display panel 1100. Thus, a touch sense rate of the display panel 1100 may be increased.

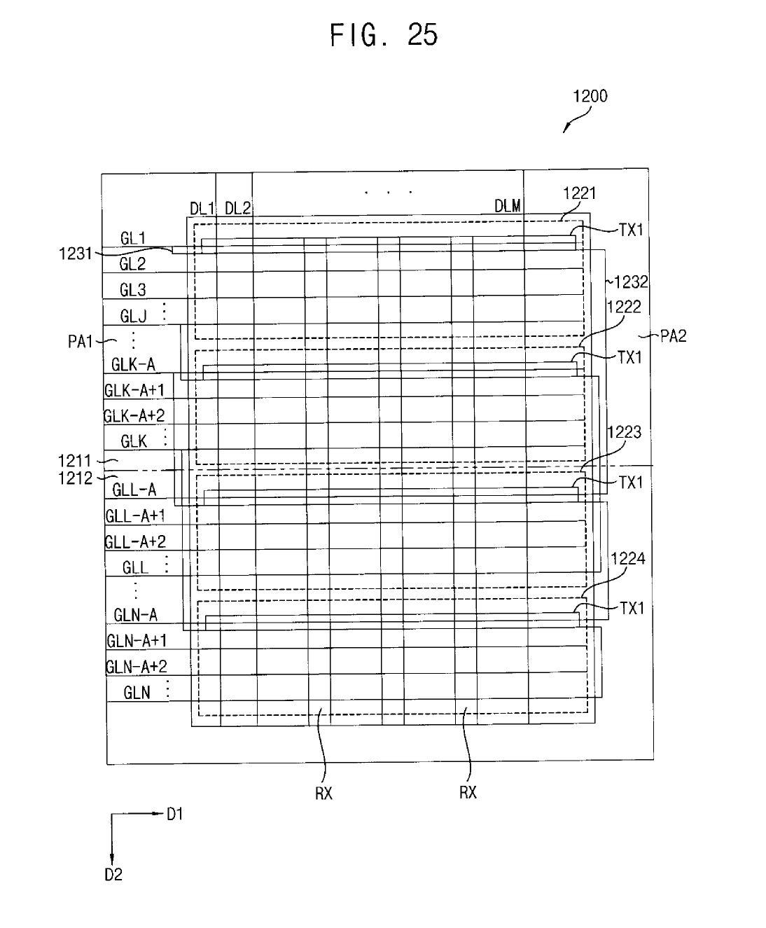

FIG. 25 is a plan view illustrating a display panel according to still another exemplary embodiment of the present invention.

The display panel 1200 according to the present exemplary embodiment is substantially the same as the display panel 700 according to the previous exemplary embodiment illustrated in FIG. 12 except for touch cells 1221, 1222, 1223, and 1224 and connection between the first transmit line TX1 and the gate lines GL1, GLJ, GLK−A, GLK, GLL−A, GLL, GLN−A and GLN. Thus, the same reference numerals will be used to refer to same or like parts as those described in the previous exemplary embodiment, and any further repetitive explanation concerning the above elements will be omitted.

The display panel 1200 includes a first area 1211 and 1212 divided based on the number of the gate lines GL1, GL2, . . . , GLN. The gate lines GL1, GL2, . . . , GLK disposed in the first area 1211 may be first area gate lines and the gate lines GLL−A, GLL−A+1, . . . , GLN disposed in the second area 1212 may be second area gate lines.

The display panel 1200 includes a plurality of touch cells 1221, 1222, 1223, and 1224. For example, the display panel 1200 may include a first touch cell 1221, a V-th (V is a natural number greater than 2) touch cell 1222, a W-th (W is a natural number greater than V) is touch cell 1223 and an X-th (X is a natural number greater than W) touch cell 1224.

Each of the touch cells 1221, 1222, 1223, and 1224 includes the first transmit line TX1. The first transmit line TX1 is connected with gate lines disposed in areas different from each other. Thus, each of the first transmit lines TX1 is connected with one of the gate lines GL1, GLJ, GLK−A, and GLK disposed in the first area 1211, and with one of the gate lines GLL−A, GLL, GLN−A, and GLN disposed in the second area 1212.

For example, the first transmit line TX1 of the first touch cell 1221 may be connected with the first gate line GL1 and the (L−A)-th gate line GLL−A, the first transmit line TX1 of the V-th touch cell 1222 may be connected with the J-th gate line GLJ and the L-th gate line GLL, the first transmit line TX1 of the W-th touch cell 1223 may be connected with the (K−A)-th gate line GLK−A and the (N−A)-th gate line GLN−A, and the first transmit line TX1 of the X-th touch cell 1224 may be connected with the K-th gate line GLK and the N-th gate line GLN.

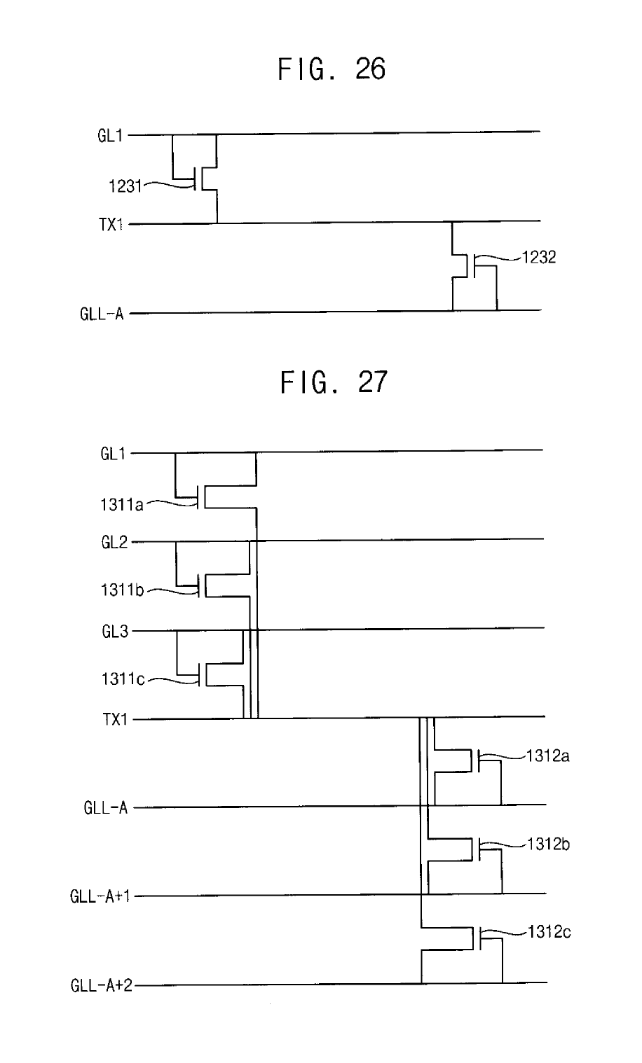

FIG. 26 is a circuit diagram illustrating a connection between the first transmit line TX1 and the gate lines GL1 and GLL−A of FIG. 25.

Referring to FIGS. 25 and 26, the first transmit line TX1 of the first touch cell 1221 and the first gate line GL1 are connected with each other through a first switching element 1231. The first transmit line TX1 and the (L−A)-th gate line GLL−A are connected with each other through a second switching element 1232.

The first switching element 1231 includes a first gate electrode connected with the first gate source line GL1, a first electrode connected with the first gate line GL1, and a first drain electrode connected with the first transmit line TX1. The second switching element 1232 includes a second gate electrode connected with the (L−A)-th gate line, a second source electrode connected with the(L−A)-th gate line, and a second drain electrode connected with the first is transmit line TX1.

A waveform diagram of gate signals applied to the gate lines GL1, GL2, . . . , GLN is substantially the same as the waveform diagram of FIG. 17. Therefore, when the first gate line GL1 is driven, the (L−A)-th gate line GLL−A is not driven, and when the (L−A)-th gate line GLL−A is driven, the first gate line GL1 is not driven. Thus, the first transmit line TX1 is selectively connected with the first gate line GL1 and the (L−A)-th gate line GLL−A.

Each of a connection between the first transmit line TX1 of the V-th touch cell 1222, the J-th gate line GLJ, and the L-th gate line GLL, a connection between the first transmit line TX1 of the W-th touch cell 1223, the (K−A)-th gate line GLK−A and the (N−A)-th gate line GLN−A, and a connection between the first transmit line TX1 of the X-th touch cell 1224, the K-th gate line GLK, and the N-th gate line GLN is substantially the same as the connection between the first transmit line TX1 of the first touch cell 1221, the first gate line GL1, and the (L−A)-th gate line GLL−A. Thus, any further repetitive explanation concerning the above elements will be omitted.

The waveform diagram of the gate signals applied to the gate lines GL1, GL2, . . . , GLN is substantially the same as the waveform diagram of FIG. 17, and thus the gate lines GL1, GL2, . . . , GLN are sequentially driven. When a frame frequency of an image data displayed on the display panel 1200 is about 60 Hz, the gate lines GL1, GL2, . . . , GLN are driven at a frequency of about 60 Hz. Thus, a driving frequency of the display panel 1200 is about 60 Hz, and a driving period of the gate lines GL1, GL2, . . . , GLN is about 16.6 ms.

When the gate lines GL1, GL2, . . . , GLK in the first area 1211 are driven, the first transmit lines TX1 of the touch cells 1221, 1222, 1223, and 1224 are driven, and thus the display panel 1200 may sense a touch. In addition, the gate lines GLL−A, . . . , GLN in the second area 1212 are driven, the first transmit lines TX1 of the touch cells 1221, 1222, 1223, and 1224 are driven, and thus the display panel 1200 may sense a touch. Therefore, when the display panel 1200 is driven, the display panel 1200 may sense the touch twice, and thus a touch sense frequency of the display panel 1200 is about 120 Hz, and a touch sense period of the display panel 1200 is about 8.3 ms.

A method of manufacturing the display panel 1200 is substantially the same as the method of manufacturing the display panel 900 described with reference to FIGS. 18A to 18E except for forming the first switching element 1231 and the second switching element 1232 when the thin-film transistor 230 is formed. Thus, any further repetitive explanation concerning the above elements will be omitted.

According to the present exemplary embodiment, each of the touch cells 1221, 1222, 1223, and 1224 includes the first transmit line TX1 connected with one of the gate lines GL1, GL2, . . . , GLK disposed in the first area 1211 and one of the gate lines GLL−A, . . . , GLN disposed in the second area 1212, and thus the touch sense frequency of the display panel 1200 is double as the driving frequency of the display panel 1200. Thus, a touch sense rate of the display panel 1200 may be increased.

FIG. 27 is a circuit diagram illustrating a connection between a first transmit line and gate lines according to still another exemplary embodiment of the present invention.

The first transmit line TX1 and the gate lines GL1, GL2, GL3, GLL−A, GLL−A+1, and GLL−A+2 are substantially the same as the first transmit line TX1 and the gate lines GL1, GL2, GL3, GLL−A, GLL−A+1, and GLL−A+2 of FIG. 25, and a display panel including the first transmit line TX1 and the gate lines GL1, GL2, GL3, GLL−A, GLL−A+1, and GLL−A+2 is substantially the same as the display panel 1200 of FIG. 25 except for the connection between is the first transmit line TX1 and the gate lines GL1, GL2, GL3, GLL−A, GLL−A+1, and GLL−A+2. Thus, the same reference numerals will be used to refer to same or like parts as those described in the previous exemplary embodiment and any further repetitive explanation concerning the above elements will be omitted.

Referring to FIG. 27, the first transmit line TX1 is connected with the gate lines GL1, GL2, and GL3 disposed in the first area 1211 through first switching elements 1311a, 1311b, and 1311c, and the second transmit line TX2 is connected with the gate lines GLL−A, GLL−A+1, and GLL−A+2 disposed in the second area 1212. The gate lines GL1, GL2, and GL3 disposed in the first area 1211 may be first area gate lines and the gate lines GLL−A, GLL−A+1, and GLL−A+2 disposed in the second area 1212 may be second area gate lines.

Each of the first switching elements 1311a, 1311b, and 1311c includes a first gate electrode connected with the gate lines GL1, GL2, and GL3, a first source electrode connected with the gate lines GL1, GL2, and GL3 and a first drain electrode connected with the first transmit line TX1. Each of the second switching elements 1312a, 1312b, and 1312c includes a second gate electrode connected with the gate lines GLL−A, GLL−A+1, and GLL−A+2, a second source electrode connected with the gate lines GLL−A, GLL−A+1, and GLL−A+2 and a second drain electrode connected with the first transmit line TX1.

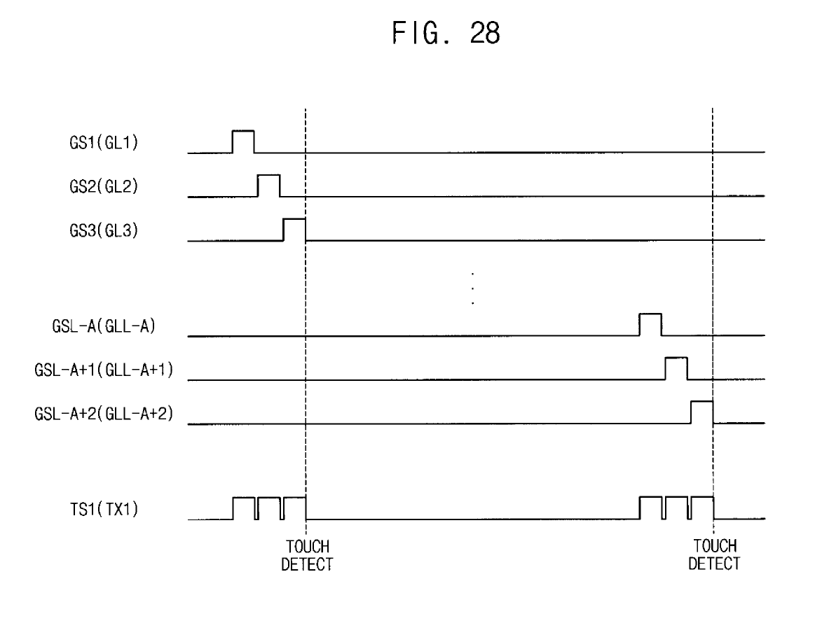

FIG. 28 is a waveform diagram illustrating gate signals applied to the gate lines GL1, GL2, GL3, GLL−A, GLL−A+1, and GLL−A+2 and a first transmit signal applied to the first transmit line TX1 of FIG. 27.

Referring to FIGS. 27 and 28, the gate lines GL1, GL2, GL3, GLL−A, GLL−A+1, and GLL−A+2 are sequentially driven. Thus, when the gate lines GL1, GL2, and GL3 disposed in the first area 1211 are driven, the display panel including the first transmit line TX1 may sense is a touch, and when the gate lines GLL−A, GLL−A+1, and GLL−A+2 disposed in the second area 1212 are driven, the display panel may sense the touch.

In addition, when the gate lines GL1, GL2, and GL3 disposed in the first area 1211 are driven, three pulses applied to the gate lines GL1, GL2, and GL3 are applied to the first transmit line TX1, and when the gate lines GLL−A, GLL−A+1, and GLL−A+2 disposed in the second area 1212 are driven, three pulses applied to the gate lines GLL−A, GLL−A+1, and GLL−A+2 are applied to the first transmit line TX1. Thus, a touch sense accuracy of the display panel may be increased.

In the present exemplary embodiment, the three gate lines GL1, GL2, and GL3 disposed in the first area 1211 and the three gate lines GLL−A, GLL−A+1, and GLL−A+2 disposed in the second area 1212 are connected to the first transmit line TX1, but the present invention is not limited thereto. For example, a plurality of gate lines disposed in the first area 1211 and a plurality of gate lines disposed in the second area 1212 may be connected to the first transmit line TX1.

According to the present exemplary embodiment, the gate lines disposed in the first area 1211 and the gate lines disposed in the second area 1212 are connected to the first transmit line TX1, and thus the gate signals applied to the gate lines are applied to the first transmit line TX1. Thus, the touch sense accuracy of the display panel including the first transmit line TX1 may be increased.

According to the display panel and method of driving the display panel, in a display panel and a display apparatus of which a display substrate including a thin-film transistor senses a touch, a touch sense frequency may be less than a driving frequency of the display panel, and thus a touch sense rate of the display panel and the display apparatus may be is increased.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A display panel comprising:
an upper substrate comprising:
a first base substrate, the first base substrate comprising a plurality of touch cells;
a plurality of gate lines disposed on the first base substrate and in the touch cells; and
a plurality of sense lines disposed in the touch cells and respectively overlapping with at least two gate lines among the gate lines; and
a lower substrate comprising a second base substrate facing the first base substrate.

2. The display panel of claim 1, wherein the plurality of sense lines comprise:
a first sense line overlapping with a first gate line of the at least two gate lines; and
a second sense line overlapping with a second gate line of the at least two gate lines, the second gate line being adjacent to the first gate line.

3. The display panel of claim 1, wherein the first substrate further comprises an insulating layer disposed between the gate lines and the sense lines.

4. The display panel of claim 1, wherein the first base substrate is disposed between the gate lines and the sense lines.

5. A display panel comprising:
a first substrate comprising a first base substrate, a plurality of gate lines disposed on the first base substrate, transmit lines respectively connected to a first area gate line and a second area gate line among the plurality of gate lines, and a receive line forming a capacitance with the transmit lines, the first area gate line and the second area gate line respectively being disposed in a first area and a second area defined based on a number of the gate lines, the first base substrate comprising a plurality of touch cells, the gate lines being in the touch cells, the transmit lines being disposed in the touch cells; and
a second substrate comprising a second base substrate facing the first base substrate.

6. The display panel of claim 5, wherein the transmit lines comprises:
a first transmit line electrically connected with the first area gate line; and
a second transmit line electrically connected with the second area gate line.

7. The display panel of claim 6, wherein the display panel comprises a display area, a first peripheral area peripheral to the display area and adjacent to a first terminal of each of the plurality of gate lines, and a second peripheral area peripheral to the display area and adjacent to a second terminal of each of the plurality of gate lines,
the first substrate further comprising a first connection line electrically connecting the first transmit line with the first area gate line and a second connection line electrically connecting the second transmit line with the second area gate line,
the first connection line is disposed in the first peripheral area and the second connection line is disposed in the second peripheral area.

8. The display panel of claim 6, wherein the display panel comprises a display area and a first peripheral area peripheral to the display area and adjacent to a first terminal of each of the plurality of gate lines,
the first substrate further comprising a first connection line electrically connecting the first transmit line with the first area gate line and a second connection line electrically connecting the second transmit line with the second area gate line, and
the first connection line and the second connection line being disposed in the first peripheral area.

9. The display panel of claim 8, wherein the first substrate further comprises a connection line layer comprising the second connection line and different from a layer comprising the first connection line.

10. The display panel of claim 5, wherein the display panel further comprises a third area disposed between the first area and the second area, and the transmit lines further comprise a third transmit line electrically connected with a third area gate line disposed in the third area.

11. The display panel of claim 5, wherein a number of the transmit lines in each of the touch cells and a number of areas of the display panel defined based on the number of the gate lines are the same.

12. The display panel of claim 5, wherein the first substrate further comprises:
a touch sense layer disposed between the first base substrate and the gate lines, the touch sense layer comprising an insulating material; and
a contact hole connecting the transmit line with the first area gate line and connecting the transmit line with the second area gate line is formed through the touch sense layer.

13. The display panel of claim 5, wherein the first substrate further comprises a first switching element configured to electrically connect the transmit line with the first area gate line and a second switching element configured to electrically connect the transmit line with the second area gate line.

14. The display panel of claim 13, wherein the first switching element comprises:
a first gate electrode connected to the first area gate line;
a first source electrode connected to the first area gate line; and
a first drain electrode connected to the transmit line, and
wherein the second switching element comprises a second gate electrode connected to the second area gate line;
a second source electrode connected to the second area gate line; and
a second drain electrode connected to the transmit line.

15. The display panel of claim 5, wherein the first substrate further comprises:
a plurality of first switching elements configured to electrically connect the transmit line with a plurality of the first area gate lines; and
a plurality of second switching elements configured to electrically connect the transmit line with a plurality of the second area gate lines.

16. The display panel of claim 15, wherein each of the plurality of first switching elements comprises:
a first gate electrode connected to the first area gate line;
a first source electrode connected to the first area gate line; and
a first drain electrode connected to the transmit line, and
wherein each of the plurality of second switching elements comprises:
a second gate electrode connected to the second area gate line;
a second source electrode connected to the second area gate line; and
a second drain electrode connected to the transmit line.

17. A method of driving a display panel, the method comprising:
driving a first gate line group comprising a first gate line and (nA+1)-th gate lines spaced apart from the first gate line at an interval of A (n is a natural number and A is a natural number equal to or greater than two), the first gate line overlapping with a first sense line, a plurality of the gate lines disposed in a plurality of touch cells comprising the first gate line group; and
driving a second gate line group comprising a second gate line and (nA+2)-th gate lines spaced apart from the second gate line at the interval of A, the second gate line overlapping with a second sense line adjacent to the first sense line, the gate lines comprising the second gate line group.

18. The method of claim 17, wherein A is two, the first gate line group comprises odd-numbered gate lines, and the second gate line group comprises even-numbered gate lines.

19. The method of claim 17, further comprising:
driving a third gate line group comprising a third gate line and (nA+3)-th gate lines spaced apart from the third gate line at the interval of A when A is equal to or greater than 3, the third gate line overlapping with a third sense line adjacent to the second sense line, the gate lines comprising the third gate line group.

20. The method of claim 17, wherein a number of the sense lines including the first and second sense lines and included in each of the touch cells is A.

21. The method of claim 17, wherein the gate lines are driven such that a touch sense frequency of the display panel is greater than a driving frequency of the display panel.

22. The method of claim 17, wherein the gate lines are driven such that a touch sense frequency of the display panel is about two times greater than a driving frequency of the display panel.

23. The method of claim 19, wherein the gate lines are driven such that a touch sense frequency of the display panel is about three times greater than a driving frequency of the display panel.
